(19) United States
(12) Patent Application Publication
(10) Pub. No.: US 2024/0319045 A1
(43) Pub. Date: Sep. 26, 2024

(54) STEAM TURBINE NOZZLE DEFORMATION AMOUNT MANAGING APPARATUS

(71) Applicant: TOSHIBA ENERGY SYSTEMS & SOLUTIONS CORPORATION, Kawasaki-shi (JP)

(72) Inventors: Yasuteru KAWAI, Yokohama Kanagawa (JP); Yusuke SUZUKI, Yokohama Kanagawa (JP); Kenichi KASE, Yokohama Kanagawa (JP); Tetsuya MAKINO, Kawasaki Kanagawa (JP); Jit Chern SANG, Kawasaki Kanagawa (JP); Tsukasa TAKEUCHI, Yokohama Kanagawa (JP); Hiroyuki ICHIKAWA, Koganei Tokyo (JP); Yasunori ONO, Yokohama Kanagawa (JP)

(73) Assignee: TOSHIBA ENERGY SYSTEMS & SOLUTIONS CORPORATION, Kawasaki-shi (JP)

(21) Appl. No.: 18/406,310

(22) Filed: Jan. 8, 2024

(30) Foreign Application Priority Data
Mar. 22, 2023 (JP) 2023-045671

(51) Int. Cl. G01M 15/14; G06T 11/20

(52) U.S. Cl. CPC G01M 15/14; G06T 11/206; G06T 2200/24

(57) ABSTRACT

A steam turbine nozzle deformation amount managing apparatus in an embodiment includes a display information generation section configured to generate display information for displaying: past deformation amount related information indicating information on a past deformation amount of a nozzle of a steam turbine from the past to the present calculated based on measured information; and future deformation amount related information indicating information on a future deformation amount of the nozzle calculated based on a future operating condition input via a user interface screen and the past deformation amount related information.

### CROSSREFERENCE TO RELATED APPLICATIONS

This application is based upon and claims the benefit of priority from Japanese Patent Application No. 2023-045671, filed on Mar. 22, 2023; the entire contents of which are incorporated herein by reference.

### FIELD

Embodiments described herein relate generally to a steam turbine nozzle deformation amount managing apparatus.

### BACKGROUND

A steam turbine includes a plurality of turbine stages provided with stator blade cascades and rotor blade cascades in the axial direction of a turbine rotor. Among the stator blade cascades, the welded-type stator blade cascade includes a welded structure in which a plurality of nozzles (stator blades) are welded in the circumferential direction between a diaphragm outer ring and a diaphragm inner ring.

The stator blade cascade having such a configuration has a risk of creep deformation over time starting from a joint portion between the nozzle and the diaphragm outer ring and a joint portion between the nozzle and the diaphragm inner ring. When the creep deformation progresses, the nozzle comes into contact with a rotary body such as a turbine rotor during operation, causing damage to turbine components or other problems. Conventionally, the amount of creep deformation of a nozzle has been directly measured during periodic inspections.

In recent years, the introduction of renewable energy has been accelerated in power generation facilities as a measure to reduce carbon dioxide (CO₂) emissions. In power generation using renewable energy, the amount of power generated varies depending on the weather or other factors. Therefore, in recent years, thermal power generation facilities have shifted to the operation mainly with regulated thermal power in order to compensate for the unstable power supply in the power generation using renewable energy. Further, due to deregulation, the interval between periodic inspections tends to be longer.

As described above, in the thermal power generation facility including a steam turbine, there is a risk that nozzle creep deformation in the steam turbine will further progress as the thermal power generation facility shifts to the regulated thermal power operation. However, as the interval between periodic inspections becomes longer, opportunities to inspect the creep deformation amount in the steam turbine decrease.

A user who manages a steam turbine in a conventional thermal power generation facility is not able to learn information on the predicted nozzle creep deformation amount from a past periodic inspection to the present, or information on the predicted future nozzle creep deformation amount based on future operating conditions of the actual steam turbine. Furthermore, in a conventional steam turbine management system, the user is not able to learn the optimal time when a periodic inspection should be performed.

### BRIEF DESCRIPTION OF THE DRAWINGS

FIG. 1 is a system diagram schematically illustrating a configuration of a steam turbine facility including a nozzle deformation amount managing apparatus in a first embodiment.

FIG. 2 is a view illustrating a meridian cross section of a high-pressure turbine, which illustrates a part of the configuration of a nozzle of the high-pressure turbine managed by the nozzle deformation amount managing apparatus in the first embodiment.

FIG. 3 is a block diagram illustrating a functional configuration of the nozzle deformation amount managing apparatus in the first embodiment.

FIG. 4 is a view illustrating one example of an input screen for future operating conditions to be displayed on a user interface in the nozzle deformation amount managing apparatus in the first embodiment.

FIG. 5 is a view illustrating one example of an input screen for inputting periodic inspection results regarding a creep deformation amount to the nozzle deformation amount managing apparatus in the first embodiment.

FIG. 6 is a flowchart for explaining the flow of arithmetic operation of a past creep deformation amount and a past strain amount in a fixed-cycle deformation amount arithmetic operation section of the nozzle deformation amount managing apparatus in the first embodiment.

FIG. 7 is a flowchart for explaining the flow of arithmetic operation of a future creep deformation amount and a future strain amount in a future deformation amount arithmetic operation section of the nozzle deformation amount managing apparatus in the first embodiment.

FIG. 8 is a view for explaining a method of calculating a recommended replacement time A, a recommended preparation time, and a preparation threshold in the future deformation amount arithmetic operation section of the nozzle deformation amount managing apparatus in the first embodiment.

FIG. 9 is a view for explaining the method of calculating the recommended replacement time A, the recommended preparation time, and the preparation threshold in the future deformation amount arithmetic operation section of the nozzle deformation amount managing apparatus in the first embodiment.

FIG. 10 is a view illustrating one example of a display screen on which display information was displayed as of the date of installation of the nozzle deformation amount managing apparatus in the first embodiment.

FIG. 11 is a flowchart for explaining a method of arithmetically operating the past creep deformation amount and the past strain amount in the nozzle deformation amount managing apparatus in the first embodiment.

FIG. 12 is a flowchart for explaining a method of arithmetically operating the future creep deformation amount and the future strain amount in the nozzle deformation amount managing apparatus in the first embodiment.

FIG. 13 is a flowchart for explaining a method of future deformation amount arithmetic operation processing in the nozzle deformation amount managing apparatus in a second embodiment.

FIG. 14 is a flowchart for explaining the method of the future deformation amount arithmetic operation processing in the nozzle deformation amount managing apparatus in the second embodiment.

FIG. 15 is a view illustrating one example of a display screen in the nozzle deformation amount managing apparatus in the second embodiment.

FIG. 16 is a view illustrating one example of a selection screen for selecting a comparison arithmetic operation result to be displayed on the user interface in the nozzle deformation amount managing apparatus in the second embodiment.

### DETAILED DESCRIPTION

There will be explained embodiments of the present invention below with reference to the drawings.

In one embodiment, a steam turbine nozzle deformation amount managing apparatus includes a display information generation section configured to generate display information for displaying: past deformation amount related information indicating information on a past deformation amount of a nozzle of a steam turbine from the past to the present calculated based on measured information; and future deformation amount related information indicating information on a future deformation amount of the nozzle calculated based on a future operating condition input via a user interface screen and the past deformation amount related information.

### First Embodiment

FIG. 1 is a system diagram schematically illustrating a configuration of a steam turbine facility 1 including a nozzle deformation amount managing apparatus 18 in the first embodiment.

As illustrated in FIG. 1, the steam turbine facility 1 includes a boiler 10, a high-pressure turbine 11, a reheater 12, an intermediate-pressure turbine 13, a low-pressure turbine 14, a generator 15, a condenser 16, a feed pump 17, and the nozzle deformation amount managing apparatus 18.

Here, the high-pressure turbine 11 and the intermediate-pressure turbine 13 function as a steam turbine whose creep deformation amount and strain amount are managed by the nozzle deformation amount managing apparatus 18. Specifically, predetermined nozzles (stator blades) of the high-pressure turbine 11 and the intermediate-pressure turbine 13 are managed by the nozzle deformation amount managing apparatus 18.

The steam turbine facility 1 includes, as a management system for calculating and managing the creep deformation amount and the strain amount of the nozzle in the steam turbine, temperature detectors 30A and 30B, pressure detectors 31A, 31B, 31C, and 31D, and an output detector 32 in addition to the nozzle deformation amount managing apparatus 18.

The boiler 10 heats feedwater to generate steam, and leads the steam to a main steam pipe 20. The high-pressure turbine 11 is turned by the steam introduced from the main steam pipe 20 and discharges the steam to a low-temperature reheat steam pipe 21. The reheater 12 reheats the steam introduced from the low-temperature reheat steam pipe 21 and leads the steam to a high-temperature reheat steam pipe 22.

The intermediate-pressure turbine 13 is turned by the steam introduced from the high-temperature reheat steam pipe 22 and discharges the steam to a crossover pipe 23. The low-pressure turbine 14 is turned by the steam introduced from the crossover pipe 23 and discharges the steam to an exhaust pipe 24. The generator 15 generates electric power by being driven by the high-pressure turbine 11, the intermediate-pressure turbine 13, and the low-pressure turbine 14. For example, the generator 15 is coaxially connected to the high-pressure turbine 11, the intermediate-pressure turbine 13, and the low-pressure turbine 14.

The condenser 16 condenses the steam introduced from the exhaust pipe 24 into condensed water. The feed pump 17 supplies the condensed water from the condenser 16 to the boiler 10 through a feed pipe 25 as feedwater.

The nozzle deformation amount managing apparatus 18 is an apparatus for calculating and managing the creep deformation amount and the strain amount of a nozzle (stator blade) in the steam turbine. Incidentally, details of the nozzle deformation amount managing apparatus 18 will be explained later.

The temperature detector 30A detects the temperature of steam to be introduced into the high-pressure turbine 11. As illustrated in FIG. 1, the temperature detector 30A is provided at the main steam pipe 20, for example, and detects the temperature at an inlet of the high-pressure turbine 11. The temperature detector 30B detects the temperature of steam to be introduced into the intermediate-pressure turbine 13. As illustrated in FIG. 1, the temperature detector 30B is provided at the high-temperature reheat steam pipe 22, for example, and detects the temperature at an inlet of the intermediate-pressure turbine 13. The temperature detectors 30A and 30B output detection signals to the nozzle deformation amount managing apparatus 18.

The pressure detector 31A detects the pressure of steam to be introduced into the high-pressure turbine 11. As illustrated in FIG. 1, the pressure detector 31A is provided at the main steam pipe 20, for example, and detects the pressure at the inlet of the high-pressure turbine 11. The pressure detector 31B detects the pressure of steam to be introduced into the intermediate-pressure turbine 13. As illustrated in FIG. 1, the pressure detector 31B is provided at the high-temperature reheat steam pipe 22, for example, and detects the pressure at the inlet of the intermediate-pressure turbine 13.

Incidentally, the inlets of the high-pressure turbine 11 and the intermediate-pressure turbine 13 described above each refer to the inlet of the turbine stage at the first stage.

The pressure detector 31C detects the steam pressure at an outlet of a rotor blade of the turbine stage at the first stage in the high-pressure turbine 11. The steam pressure at the outlet of the rotor blade will be referred to as rotor blade outlet pressure below. Incidentally, the pressure detector 31C may detect the steam pressure at the inlet of the nozzle of the turbine stage at the first stage in the high-pressure turbine 11. The steam pressure at the inlet of the nozzle will be referred to as nozzle inlet pressure below. Further, the steam pressure at an outlet of the nozzle is referred to as nozzle outlet pressure. The pressure detector 31D detects the nozzle outlet pressure of the turbine stage at the first stage in the intermediate-pressure turbine 13.

The pressure detectors 31A, 31B, 31C, and 31D output detection signals to the nozzle deformation amount managing apparatus 18.

The output detector 32 detects the electrical output of the generator 15 to output a detection signal of the detected electrical output to the nozzle deformation amount managing apparatus 18.

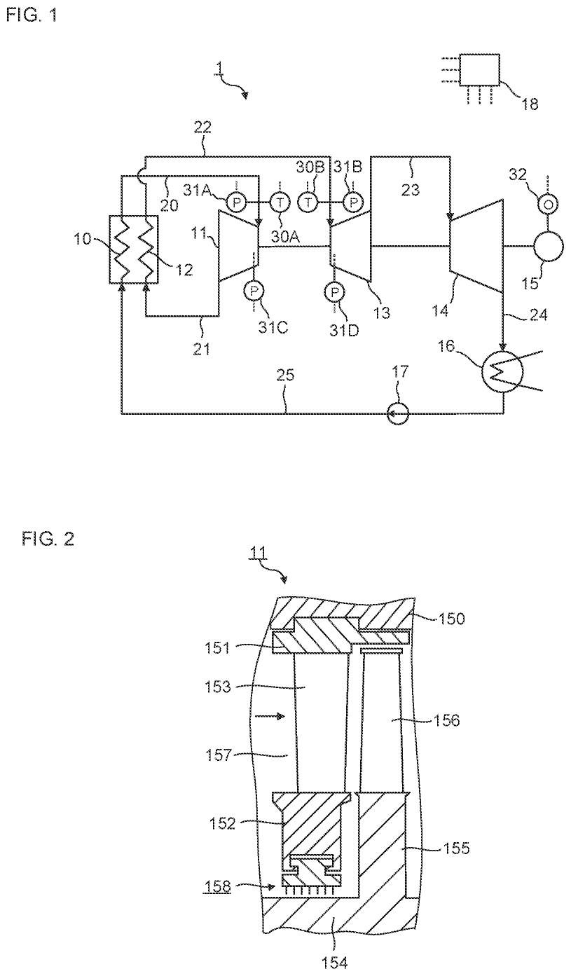

Here, there is explained a configuration of a nozzle 153 whose creep deformation amount and strain amount are managed in the nozzle deformation amount managing apparatus 18. FIG. 2 is a view illustrating a meridian cross section of the high-pressure turbine 11, which illustrates a part of the configuration of the nozzle 153 of the high-pressure turbine 11 managed by the nozzle deformation amount managing apparatus 18 in the first embodiment. Here, the configuration of the nozzle 153 of the high-pressure turbine 11 is explained as an example. Incidentally, the configuration of a nozzle of the intermediate-pressure turbine 13 is also the same as that of the nozzle 153 of the high-pressure turbine 11.

A diaphragm outer ring 151 is installed on the inner periphery of a casing 150 of the high-pressure turbine 11, and a diaphragm inner ring 152 is installed at an inner side of this diaphragm outer ring 151. A plurality of the nozzles (stator blades) 153 are arranged in the circumferential direction between the diaphragm outer ring 151 and the diaphragm inner ring 152 to form a stator blade cascade. A plurality of rotor blades 156, which are planted on a rotor wheel 155 of a turbine rotor 154, are provided downstream of the stator blade cascade. A plurality of the rotor blades 156 are arranged in the circumferential direction to form a rotor blade cascade.

A plurality of stator blade cascades are provided in the axial direction of the turbine rotor 154, alternating with rotor blade cascades. Then, the stator blade cascade and the rotor blade cascade located immediately downstream of the stator blade cascade form one turbine stage.

An annular steam passage 157 through which steam flows is formed between the diaphragm outer ring 151 and the diaphragm inner ring 152. Incidentally, in FIG. 2, the flow direction of steam is indicated by an arrow. A sealing portion 158 is provided between the turbine rotor 154 and the diaphragm inner ring 152 in order to prevent steam from passing downstream between them.

Here, the deformation amount to be managed by the nozzle deformation amount managing apparatus 18 includes the creep deformation amount due to creep deformation and the strain amount calculated based on the creep deformation amount. Incidentally, these deformation amounts will be explained later. The creep deformation is explained with reference to FIG. 2 here. In the stator blade cascade described above, the diaphragm inner ring 152 is deformed over time in the flow direction of steam with the diaphragm outer ring 151 set as a fixed end and the diaphragm inner ring 152 set as a free end. Further, the nozzle 153 is also deformed with this deformation. Here, such deformation is referred to as creep deformation.

The creep deformation becomes noticeable when a metal material is used in an environment at a temperature about half of its melting point. Here, the nozzle deformation amount managing apparatus 18 manages, for example, the creep deformation amount and the strain amount of the nozzle 153 having the above-described configuration, which is used in an environment at a temperature of 480° C. or more. Further, the nozzle 153 to be managed by the nozzle deformation amount managing apparatus 18 is the nozzle 153 arranged between the diaphragm outer ring 151 and the diaphragm inner ring 152 as illustrated in FIG. 2. Incidentally, the nozzle deformation amount managing apparatus 18 manages the nozzle 153 having the above-described configuration, which is used in an environment at a temperature of 480° C. or more, in the intermediate-pressure turbine 13 as well.

The nozzle to be managed by the nozzle deformation amount managing apparatus 18 is a welded-type nozzle 153 fixed to the diaphragm outer ring 151 and the diaphragm inner ring 152 by welding. Then, the stator blade cascade is a welded-type stator blade cascade in which a plurality of the nozzles 153 are welded in the circumferential direction between the diaphragm outer ring 151 and the diaphragm inner ring 152. Further, examples of the nozzle to be managed in the nozzle deformation amount managing apparatus 18 include the nozzles of the turbine stages at the second to fourth stages in the high-pressure turbine 11, the nozzles of the turbine stage at the second stage in the intermediate-pressure turbine 13, and so on. Incidentally, the nozzles to be managed in the nozzle deformation amount managing apparatus 18 are not limited to these nozzles, and for example, any nozzle with the above-described configuration to be used in an environment at a temperature of 480° C. or more can be applied.

Next, the nozzle deformation amount managing apparatus 18 is explained.

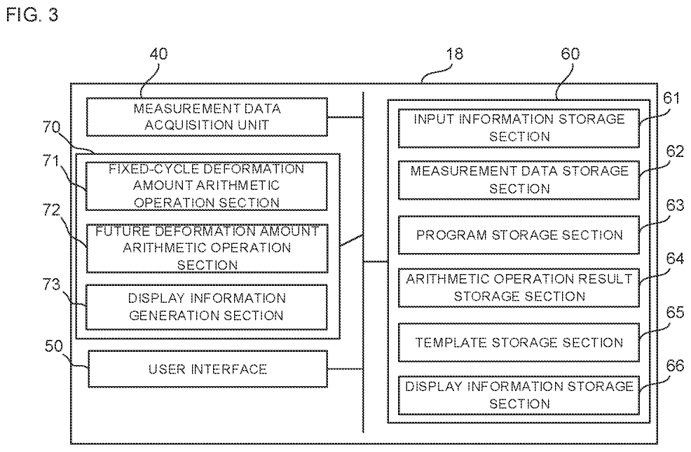

FIG. 3 is a block diagram illustrating a functional configuration of the nozzle deformation amount managing apparatus 18 in the first embodiment. The nozzle deformation amount managing apparatus 18 is, for example, an apparatus that predicts and manages a creep deformation amount and a strain amount from the past to the present based on operation data of the actual steam turbine, and a future creep deformation amount and strain amount based on assumed future operating conditions. Further, the nozzle deformation amount managing apparatus 18 generates display information for displaying predicted results such as the creep deformation amount and the strain amount on a display part, for example.

As illustrated in FIG. 3, the nozzle deformation amount managing apparatus 18 includes a measurement data acquisition unit 40, a user interface 50, a storage unit 60, and an arithmetic operation unit 70.

The measurement data acquisition unit 40 is an interface that acquires detection signals related to the steam temperatures output from the temperature detectors 30A and 30B, detection signals related to the steam pressures output from the pressure detectors 31A, 31B, 31C, and 31D, and a detection signal related to the electrical output output from the output detector 32. The measurement data acquisition unit 40 acquires these detection signals at predetermined time intervals. The measurement data acquisition unit 40 acquires the detection signals at one-hour intervals, for example.

The measurement data acquisition unit 40 has a function of converting the acquired detection signals into steam temperature information, steam pressure information, and electrical output information respectively, based on the acquired detection signals related to the steam temperature, the acquired detection signals related to the steam pressure, and the acquired detection signal related to the electrical output. The measurement data acquisition unit 40 outputs the converted steam temperature information, steam pressure information, and electrical output information to a measurement data storage section 62 of the storage unit 60.

The user interface 50 includes a display part that displays various pieces of information to a user (manager), and an input device through which the user inputs various pieces of information. The display part is configured by a display, and the like, for example. Further, the display part may be configured by a touch panel having a function as a display screen and a function as an input device that allows direct input to the screen. The input device is configured by a keyboard, a mouse, and the like, for example.

The storage unit 60 includes an input information storage section 61, the measurement data storage section 62, a program storage section 63, an arithmetic operation result storage section 64, a template storage section 65, and a display information storage section 66. The storage unit 60 is fabricated by, for example, a hard disk drive, a nonvolatile memory device, or the like. The storage unit 60 may be in a form that is not physically integrated with the nozzle deformation amount managing apparatus 18, but is connected thereto via a not-illustrated network.

The input information storage section 61 stores, for example, future operating conditions, various setting conditions, and so on that are input via the user interface 50. Further, the input information storage section 61 stores, for example, various setting conditions, design information of the nozzle to be managed, information on periodic inspection results related to the creep deformation amount, and so on, which are input from an input device at a manufacturer that manufactures the nozzle deformation amount managing apparatus 18.

Here, the future operating conditions are used in arithmetic operations to predict the future creep deformation amount and strain amount. The future operating conditions are future operating conditions in the steam turbine facility 1. The future operating condition includes an operating time per day (24 hours) for each classified load and an annual availability factor. Examples of the future operating condition include a preset default operation mode, a customized operation mode in which a user arbitrarily sets an operating time for each classified load and an annual availability factor, and so on. Here, the “classified load” refers to a load obtained by classifying the load range of a steam turbine (for example, a range from 0% load to 100% load) in units of predetermined load (for example, in units of 10% load). For example, when the load range of the steam turbine from 0% load to 100% load is classified in units of 10% load, the classified loads are 10% load, 20% load, 30% load, 40% load, 50% load, 60% load, 70% load, 80% load, 90% load, and 100% load.

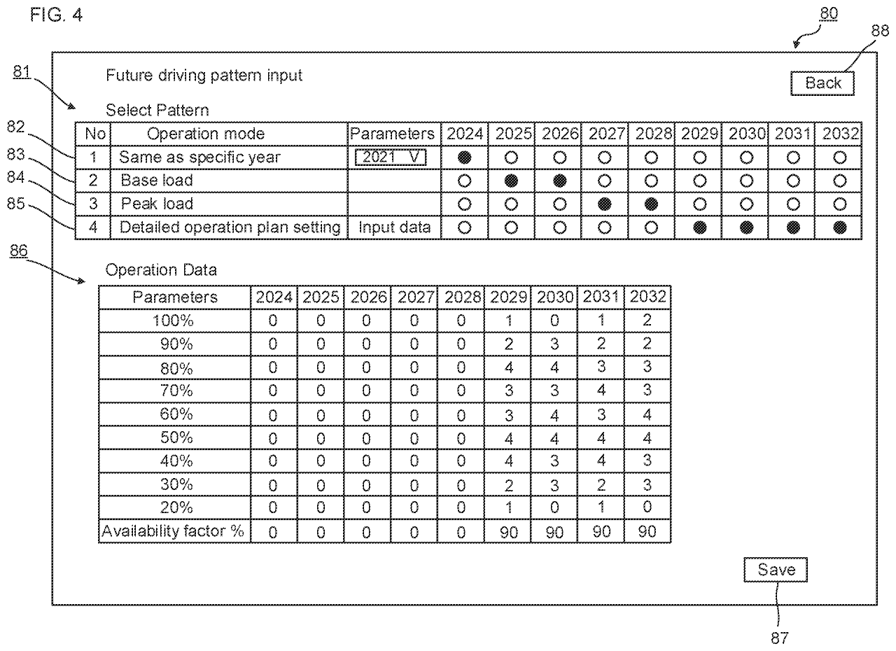

FIG. 4 is a view illustrating one example of an input screen 80 for future operating conditions to be displayed on the user interface 50 in the nozzle deformation amount managing apparatus 18 in the first embodiment.

In FIG. 4, as the default operation mode, for example, a past operation performance mode (Same as specific year) 82, a base load operation mode (Base load) 83, and a peak load operation mode (Peak load) 84 have been set. As the customized operation mode, a detailed operation setting mode (Detailed operation plan setting) 85 has been set.

The input screen 80 illustrated in FIG. 4 is one example of a screen selected and input by the user via the user interface 50. In Select Pattern 81 at the top of FIG. 4, the user selects a white circle in the column of Operation mode to be selected for each year and changes it to a black circle. In the input screen 80 illustrated in FIG. 4, the past operation performance mode 82 has been selected for year 2024, the base load operation mode 83 has been selected for year 2025 and year 2026, the peak load operation mode 84 has been selected for year 2027 and year 2028, and the detailed operation setting mode 85 has been selected for year 2029 to year 2032.

Incidentally, although the period up to year 2032 has been illustrated in FIG. 4, the present invention is not limited to this period. For example, a further period such as a period of year 2040 may be set as the period.

The past operation performance mode 82 is a mode in which operation is performed in the same operation pattern as that of the selected year. In the past operation performance mode 82, the operation mode is set based on the classified loads in units of 10% load and the operating time in each classified load, which are calculated from the operation data from January to December of the selected year. Further, in the past operation performance mode 82, the operation mode is set based on the availability factor (Availability factor) of the selected year. Incidentally, in FIG. 4, the operation pattern for year 2021 has been selected.

Here, the availability factor is a ratio of the number of days in which the steam turbine facility 1 is operated in one year for each year. That is, the availability factor is a value obtained by dividing the number of days in which the steam turbine facility 1 is operated in one year by 365 days and expressing the result as a percentage of 100.

The base load operation mode 83 is a mode in which operation is performed at a high load in the range of 70% load to 100% load, for example. In the base load operation mode 83, classified loads, which are obtained by classifying the load range from 70% load to 100% load in units of 10% load, are set, for example. Further, in the base load operation mode 83, the availability factor has been set for each year.

Incidentally, the base load operation mode 83 is a default value, and is set with reference to past operation data in the steam turbine facility 1, for example. The base load operation mode 83 is set, for example, on an annual basis.

Table 1 illustrates one example of the base load operation mode 83.

TABLE 1

| | | Year | | | | | | | | |
|---|---|---|---|---|---|---|---|---|---|---|
| | | 2024 | 2025 | 2026 | 2027 | 2028 | 2029 | 2030 | 2031 | 2032 |
| Load | 100% | 3 hour | 4 hour | 5 hour | 6 hour | 4 hour | 3 hour | 6 hour | 5 hour | 4 hour |
| | 90% | 10 hour | 9 hour | 11 hour | 8 hour | 12 hour | 11 hour | 9 hour | 11 hour | 10 hour |
| | 80% | 9 hour | 8 hour | 7 hour | 8 hour | 5 hour | 8 hour | 8 hour | 5 hour | 8 hour |
| | 70% | 2 hour | 3 hour | 1 hour | 2 hour | 3 hour | 2 hour | 1 hour | 3 hour | 2 hour |

| | | | | | | | | | |
|---|---|---|---|---|---|---|---|---|---|
| Availability factor, % | 89 | 89 | 89 | 89 | 89 | 89 | 89 | 89 | 89 |

Table 1 illustrates one example in which the operating time per day (24 hours) is set for each classified load in each year from year 2024 to year 2032. As illustrated in Table 1, for example, as the base load operation mode 83 for year 2024, 100% load (rated load): 3 hours, 90% load: 10 hours, 80% load: 9 hours, and 70% load: 2 hours have been set. Further, the availability factor has been set to 89%.

Incidentally, the base load operation mode 83 is a default value, and is set with reference to past operation data in the steam turbine facility 1, for example. Further, although there has been explained one example in which the load range from 100% load to 70% load is classified in units of 10% load as the base load operation mode 83 here, the present invention is not limited to this setting. The load range in the base load operation mode 83 may be set wider or narrower than the range in the above-described example. Further, the load unit may be set wider or narrower than the 10% load unit. Further, the number of years to be set may be smaller or larger than the number of years set in Table 1.

The peak load operation mode 84 is a mode in which operation is performed with load variations in the range from a low load to a rated load (100% load). In the peak load operation mode 84, for example, classified loads, which are obtained by classifying the load range from 100% load to 20% load in units of 10% load, are set. The peak load operation mode 84 is set on an annual basis. Table 2 illustrates one example of the peak load operation mode 84.

TABLE 2

| | | Year | | | | | | | | |
|---|---|---|---|---|---|---|---|---|---|---|
| | | 2024 | 2025 | 2026 | 2027 | 2028 | 2029 | 2030 | 2031 | 2032 |
| Load | 100% | 1 hour | 1 hour | 1 hour | 1 hour | 1 hour | 1 hour | 1 hour | 1 hour | 1 hour |
| | 90% | 5 hour | 5 hour | 5 hour | 5 hour | 5 hour | 6 hour | 7 hour | 7 hour | 4 hour |
| | 80% | 2 hour | 2 hour | 2 hour | 2 hour | 2 hour | 2 hour | 2 hour | 2 hour | 2 hour |
| | 70% | 1 hour | 1 hour | 1 hour | 2 hour | 2 hour | 1 hour | 1 hour | 1 hour | 2 hour |
| | 60% | 1 hour | 1 hour | 1 hour | 1 hour | 1 hour | 1 hour | 1 hour | 1 hour | 1 hour |
| | 50% | 1 hour | 1 hour | 2 hour | 2 hour | 2 hour | 1 hour | 1 hour | 2 hour | 2 hour |
| | 40% | 4 hour | 2 hour | 2 hour | 2 hour | 3 hour | 3 hour | 2 hour | 2 hour | 2 hour |
| | 30% | 8 hour | 3 hour | 3 hour | 3 hour | 3 hour | 8 hour | 3 hour | 2 hour | 3 hour |
| | 20% | 1 hour | 8 hour | 7 hour | 6 hour | 5 hour | 1 hour | 6 hour | 6 hour | 7 hour |

| | | | | | | | | | |
|---|---|---|---|---|---|---|---|---|---|
| Availability factor, % | 89 | 89 | 89 | 89 | 89 | 89 | 89 | 89 | 89 |

In Table 2, the operating time per day (24 hours) has been set for each classified load in each year from year 2024 to year 2032. For example, as the peak load operation mode 84 in year 2024, 100% load (rated load): 1 hour, 90% load: 5 hours, 80% load: 2 hours, 70% load: 1 hour, 60% load: 1 hour, 50% load: 1 hour, 40% load: 4 hours, 30% load: 8 hours, and 20% load: 1 hour have been set. Further, the availability factor has been set to 89%.

Incidentally, the peak load operation mode 84 is a default value, and is set with reference to past operation data in the steam turbine facility 1, for example. Further, although there has been explained one example in which the load range from 100% load to 20% load is classified in units of 10% load as the peak load operation mode 84 here, the present invention is not limited to this setting. The load range in the peak load operation mode 84 may be set wider or narrower than the range in the above-described example. Further, the load unit may be set wider or narrower than the 10% load unit. Further, the number of years to be set may be smaller or larger than the number of years set in Table 2.

In the detailed operation setting mode 85, the operating time per day (24 hours) is arbitrarily set for each classified load illustrated in the column of Operation Data 86 at the bottom in FIG. 4. Further, the availability factor is also set arbitrarily. The user inputs the operating time for each classified load in the column of year in the detailed operation setting mode 85. In FIG. 4, the operating time has been input in the columns of 2029 to 2032 in which the detailed operation setting mode 85 is set.

Further, although there has been explained one example in which the load range from 100% load to 20% load is classified in units of 10% load as Operation Data 86 in the detailed operation setting mode 85 here, the present invention is not limited to this setting. The load range in the detailed operation setting mode 85 may be set wider or narrower than the range in the above-described example. Further, the load unit may be set wider or narrower than the 10% load unit.

Here, the user who has input the above-described future operating condition presses a Save button 87 in FIG. 4. The user interface 50 receives input from the Save button 87 and outputs information related to the future operating condition to the input information storage section 61. The input information storage section 61 receives and stores the information related to the future operating condition.

Further, the input information storage section 61 has stored a correspondence table of the steam temperature information and the steam pressure information at the inlet of the high-pressure turbine 11, the steam pressure information related to the nozzle inlet pressure and the nozzle outlet pressure of the nozzle to be managed in the high-pressure turbine 11, the steam temperature information related to the steam temperature at the nozzle inlet of the nozzle to be managed in the high-pressure turbine 11, the steam temperature information and the steam pressure information at the inlet of the intermediate-pressure turbine 13, the steam pressure information related to the nozzle inlet pressure and the nozzle outlet pressure of the nozzle to be managed in the intermediate-pressure turbine 13, the steam temperature information related to the steam temperature at the nozzle inlet of the nozzle to be managed in the intermediate-pressure turbine 13, and the electrical output information of the generator 15, which is set based on a heat balance, corresponding to classified loads in the future operating condition. Incidentally, the steam temperature at the nozzle inlet is referred to as a nozzle inlet temperature below.

This allows a future deformation amount arithmetic operation section 72 to arithmetically operate the future creep deformation amount and strain amount based on the steam temperature information, the steam pressure information, and the electrical output information, because the steam temperature information, the steam pressure information, and the electrical output information have been stored for each classified load of the future operating condition, for example.

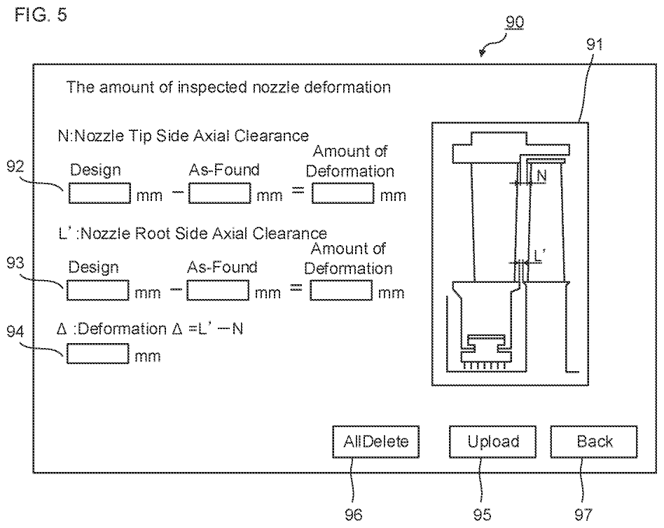

Further, the input information storage section 61 stores information on periodic inspection results related to the creep deformation amount, and so on. Here, FIG. 5 is a view illustrating one example of an input screen 90 for inputting periodic inspection results regarding the creep deformation amount to the nozzle deformation amount managing apparatus 18 in the first embodiment. Incidentally, the periodic inspection results are input by the manufacturer, for example. The input screen 90 illustrated in FIG. 5 is displayed on, for example, an operation screen of the input device at the manufacturer. Then, the information related to the periodic inspection results from the input device at the manufacturer is output to the input information storage section 61. The input information storage section 61 receives and stores the information related to the periodic inspection results. Incidentally, the input device at the manufacturer is set to be able to access the nozzle deformation amount managing apparatus 18.

“N: Nozzle Tip Side Axial Clearance” illustrated on the input screen 90 in FIG. 5 is the distance between an axial downstream end at a radially inner peripheral surface of the diaphragm outer ring that is in contact with the tip of the nozzle on the radially outer side and an axial upstream end of a shroud at the tip of the rotor blade. “L′: Nozzle Root Side Axial Clearance” is the distance between an axial downstream end at a radially outer peripheral surface of the diaphragm inner ring that is in contact with the blade root end of the nozzle on the radially inner side and an axial upstream end of a platform that is in contact with the blade root end of a blade effective portion of the rotor blade. “Δ: Deformation” is the length (L′-N) obtained by subtracting N from L′.

Incidentally, N and L′ are illustrated in a blade configuration display portion 91 where the configuration of the nozzle and the rotor blade is schematically illustrated. In the blade configuration display portion 91, the nozzle is on the left side and the rotor blade is on the right side. Further, the radial direction is the direction perpendicular to the center axis of the turbine rotor.

In numerical value columns 92 and 93 of N and L′, initial values (Design) and numerical values based on periodic inspection results (As-Found) are input. When the initial values and the numerical values based on the periodic inspection results are input in the numerical value columns 92 and 93 of N and L′, the creep deformation amounts (Amount of Deformation) are displayed. After inputting the numerical values of N and L′, the difference between the creep deformation amounts, which is the value of “L′-N”, is displayed in a numerical value column 94 of Δ (Deformation).

Then, the input device at the manufacturer receives input from an Upload button 95 and outputs information related to the periodic inspection results to the input information storage section 61. The input information storage section 61 receives and stores the information related to the periodic inspection results. Incidentally, the input device at the manufacturer receives input from an All Delete button 96 and deletes, for example, the numerical values in the numerical value columns 92, 93, and 94.

Incidentally, although there has been explained one example in which the manufacturer inputs the periodic inspection results here, the present invention may be set so that the user can input the results. In this case, the input screen 90 illustrated in FIG. 5 is displayed on the display part of the user interface 50. When the user inputs the periodic inspection results, the user presses the Upload button 95 after inputting the periodic inspection results. Then, the user interface 50 receives input from the Upload button 95 and outputs information related to the periodic inspection results to the input information storage section 61. The input information storage section 61 receives and stores the information related to the periodic inspection results. Incidentally, a Back button 97 on the input screen 90 is a button to be pressed when returning to a later-described display screen 100 without pressing the Upload button 95.

Incidentally, the information related to the latest periodic inspection results is an initial value when arithmetically operating the creep deformation amount and the strain amount in a fixed-cycle deformation amount arithmetic operation section 71, for example.

The input information storage section 61 stores a replacement threshold A, which is a creep deformation amount at which the nozzle should be replaced, and a replacement threshold B, which is a strain amount at which the nozzle should be replaced. Here, it is recommended that the nozzle whose creep deformation amount has reached the replacement threshold A or whose strain amount has reached the replacement threshold B should be replaced. The replacement threshold A and the replacement threshold B are default values set based on the specifications or the like of the nozzle, for example. Therefore, the replacement threshold A and the replacement threshold B have been stored in the input information storage section 61 in advance.

Incidentally, the manufacturer stores the replacement threshold A and the replacement threshold B in the input information storage section 61 in advance. Further, for example, the manufacturer can change the replacement threshold A and the replacement threshold B in accordance with changes in management values or the like.

The input information storage section 61 stores an inspection threshold A, which is a creep deformation amount at which the nozzle should be inspected, and an inspection threshold B, which is a strain amount at which the nozzle should be inspected. Here, it is recommended that the nozzle whose creep deformation amount has reached the inspection threshold A or whose strain amount has reached the inspection threshold B should be inspected. The inspection threshold A and the inspection threshold B are default values set based on the specifications or the like of the nozzle, for example. Therefore, the inspection threshold A and the inspection threshold B have been stored in the input information storage section 61 in advance.

Incidentally, the manufacturer stores the inspection threshold A and the inspection threshold B in the input information storage section 61 in advance. Further, for example, the manufacturer can change the inspection threshold A and the inspection threshold B in accordance with changes in management values or the like.

The input information storage section 61 has stored, as an initial value (for example, 3 years), a preparation period for determining a later-described recommended preparation time, when the nozzle deformation amount managing apparatus 18 is installed. The preparation period is a period required to prepare a new nozzle. Incidentally, the user can change the preparation period from the initial value to a predetermined period by making a request to the manufacturer. In this case, information related to the changed preparation period is output from the input device at the manufacturer to the input information storage section 61 of the nozzle deformation amount managing apparatus 18. Then, the input information storage section 61 stores the information related to the changed preparation period.

The measurement data storage section 62 stores the steam temperature information, the steam pressure information, and the electrical output information output from the measurement data acquisition unit 40. The measurement data storage section 62 stores the steam temperature information, the steam pressure information, and the electrical output information output from the measurement data acquisition unit 40 every hour, for example.

The program storage section 63 stores programs for executing calculations of the creep deformation amount, the strain amount, and the like and management of the creep deformation amount and the strain amount in the nozzle deformation amount managing apparatus 18, as well as various arithmetic expressions/equations, various parameters, and the like for calculating the creep deformation amount, the strain amount, and the like.

The arithmetic operation result storage section 64 stores results arithmetically operated in the arithmetic operation unit 70. The arithmetic operation result storage section 64 stores information on the creep deformation amount and the strain amount from the past to the present, which are arithmetically operated in the fixed-cycle deformation amount arithmetic operation section 71, for example. Here, the arithmetic operation result storage section 64 stores, for example, arithmetic operation results of the creep deformation amount and the strain amount from the past to the present, and the like, as the information on the creep deformation amount and the strain amount from the past to the present. Incidentally, this information functions as past deformation amount related information.

The arithmetic operation result storage section 64 stores information on the future creep deformation amount and strain amount arithmetically operated in the future deformation amount arithmetic operation section 72, for example. The arithmetic operation result storage section 64 stores a recommended replacement time A at which the future creep deformation amount calculated by the arithmetic operation in the future deformation amount arithmetic operation section 72 reaches the replacement threshold A and a recommended replacement time B at which the future strain amount calculated by the arithmetic operation in the future deformation amount arithmetic operation section 72 reaches the replacement threshold B. Incidentally, the recommended replacement time A and the recommended replacement time B are specified by year, month, and day. The method of calculating these recommended replacement times will be explained later.

Here, the time before a predetermined preparation period from the earlier of the recommended replacement time A and the recommended replacement time B is set as the recommended preparation time. The recommended preparation time refers to the time at which it is recommended to start preparation for a new nozzle for the nozzle whose recommended replacement time has been specified. Incidentally, the recommended preparation time is also specified by year, month, and day, similarly to the recommended replacement time. For example, when the earlier of the recommended replacement time A and the recommended replacement time B is Jun. 1, 2040 and the preparation period is 3 years, the recommended preparation time is Jun. 1, 2037. The preparation period has been stored in the input information storage section 61, as described previously.

The arithmetic operation result storage section 64 stores as a preparation threshold the future creep deformation amount or strain amount at the recommended preparation time, which is arithmetically operated by the future deformation amount arithmetic operation section 72. That is, the creep deformation amount or the strain amount at the recommended preparation time is the preparation threshold. The method of calculating the preparation threshold will be explained later.

Further, the arithmetic operation result storage section 64 stores a recommended inspection time A at which the future creep deformation amount reaches the inspection threshold A and a recommended inspection time B at which the strain amount reaches the inspection threshold B, which are calculated by the arithmetic operation in the future deformation amount arithmetic operation section 72. Incidentally, the recommended inspection time A and the recommended inspection time B are specified by year, month, and day. The method of calculating these recommended inspection times will be explained later.

The arithmetic operation result storage section 64 stores, as the information on the future creep deformation amount and strain amount, the arithmetic operation results of the future creep deformation amount and strain amount, the recommended replacement time A, the recommended replacement time B, the recommended inspection time A, the recommended inspection time B, the preparation threshold, the recommended preparation time, and the like, for example. Incidentally, these pieces of information function as future deformation amount related information.

The template storage section 65 stores information related to template screens that serve as bases for the screens that display the arithmetic operation results stored in the arithmetic operation result storage section 64. Pieces of information related to various template screens to be displayed on the display part of the user interface 50 have been stored in the template storage section 65 in advance.

The display information storage section 66 stores display information to be displayed on the display part, which is generated in a display information generation section 73 of the arithmetic operation unit 70.

The arithmetic operation unit 70 is an arithmetic operation block including the fixed-cycle deformation amount arithmetic operation section 71, the future deformation amount arithmetic operation section 72, and the display information generation section 73. The arithmetic operation unit 70 reads a program for executing the nozzle deformation amount managing apparatus 18 from the program storage section 63 in response to an execution start input by the user from the user interface 50. This makes it possible to execute the functions of the fixed-cycle deformation amount arithmetic operation section 71, the future deformation amount arithmetic operation section 72, and the display information generation section 73.

The fixed-cycle deformation amount arithmetic operation section 71 is an arithmetic operation block that reads arithmetic expressions/equations and parameters for calculating the creep deformation amount and the strain amount from the program storage section 63 and calculates the creep deformation amount and the strain amount in a fixed-cycle based on the steam temperature information, the steam pressure information, and the electrical output information stored in the measurement data storage section 62. The fixed-cycle deformation amount arithmetic operation section 71 outputs information related to the calculated creep deformation amount and strain amount to the arithmetic operation result storage section 64. Here, the fixed-cycle refers to, for example, a one-hour cycle from a predetermined date in the past to the present. The fixed-cycle deformation amount arithmetic operation section 71 calculates the creep deformation amount and the strain amount every fixed-cycle (for example, every hour) based on the steam temperature information, the steam pressure information, and the electrical output information, while using the creep deformation amount measured during a periodic inspection on a predetermined date in the past as an initial value. Then, the creep deformation amount at the present is calculated by adding the creep deformation amount that has progressed from a predetermined date in the past to the present to the creep deformation amount measured during the periodic inspection on the predetermined date in the past. Incidentally, the creep deformation amount that has progressed from the predetermined date in the past to the present and the strain amount, which are calculated by the fixed-cycle deformation amount arithmetic operation section 71, are predicted values.

The fixed-cycle deformation amount arithmetic operation section 71 determines whether or not the calculated creep deformation amount has reached the replacement threshold A based on the replacement threshold A stored in the input information storage section 61. Further, the fixed-cycle deformation amount arithmetic operation section 71 determines whether or not the calculated strain amount has reached the replacement threshold B based on the replacement threshold B stored in the input information storage section 61.

The fixed-cycle deformation amount arithmetic operation section 71 determines whether or not the calculated creep deformation amount has reached the inspection threshold A based on the inspection threshold A stored in the input information storage section 61. Further, the fixed-cycle deformation amount arithmetic operation section 71 determines whether or not the calculated strain amount has reached the inspection threshold B based on the inspection threshold B stored in the input information storage section 61.

Further, the fixed-cycle deformation amount arithmetic operation section 71 determines whether or not the calculated creep deformation amount or strain amount has reached the preparation threshold based on the preparation threshold stored in the input information storage section 61. Incidentally, the operations related to these determinations in the fixed-cycle deformation amount arithmetic operation section 71 will be explained later.

The future deformation amount arithmetic operation section 72 is an arithmetic operation block that reads arithmetic expressions/equations and parameters for calculating the creep deformation amount and the strain amount from the program storage section 63 and calculates the future creep deformation amount and strain amount based on the future operating conditions stored in the input information storage section 61. The future deformation amount arithmetic operation section 72 outputs information related to the calculated creep deformation amount and strain amount to the arithmetic operation result storage section 64.

Here, the future refers to the period from the present to a year in the future set as the future operating condition. The future deformation amount arithmetic operation section 72 calculates the future creep deformation amount and strain amount every predetermined year (for example, every year) based on the future operating condition stored in the input information storage section 61, while using the present creep deformation amount and strain amount calculated in the fixed-cycle deformation amount arithmetic operation section 71 as initial values. Incidentally, the future creep deformation amount and strain amount calculated by the future deformation amount arithmetic operation section 72 are predicted values.

The future deformation amount arithmetic operation section 72 determines whether or not the future creep deformation amount has reached the replacement threshold A based on the replacement threshold A stored in the input information storage section 61 and the calculated future creep deformation amount. When determining that the future creep deformation amount has reached the replacement threshold A, the future deformation amount arithmetic operation section 72 calculates the recommended replacement time A at which the future creep deformation amount reaches the replacement threshold A.

Further, the future deformation amount arithmetic operation section 72 determines whether or not the future strain amount has reached the replacement threshold B based on the replacement threshold B stored in the input information storage section 61 and the calculated future strain amount. When determining that the future strain amount has reached the replacement threshold B, the future deformation amount arithmetic operation section 72 calculates the recommended replacement time B at which the future strain amount reaches the replacement threshold B.

Further, when determining that the future creep deformation amount has reached the replacement threshold A or the future strain amount has reached the replacement threshold B, the future deformation amount arithmetic operation section 72 calculates the recommended preparation time and the preparation threshold based on the preparation period described previously.

Here, for convenience of explanation, the creep deformation amount and the strain amount from the past to the present that are arithmetically operated by the fixed-cycle deformation amount arithmetic operation section 71 are referred to as the past creep deformation amount and the past strain amount respectively. The creep deformation amount and the strain amount from the present to a predetermined date in the future that are arithmetically operated by the future deformation amount arithmetic operation section 72 are referred to as the future creep deformation amount and the future strain amount respectively.

The display information generation section 73 is an arithmetic operation block that generates display information to be displayed on the display part of the user interface 50. The display information generation section 73 generates display information based on the information stored in the arithmetic operation result storage section 64 and the template storage section 65. Incidentally, the display information generation section 73 may directly receive the arithmetic operation results of the fixed-cycle deformation amount arithmetic operation section 71 and the future deformation amount arithmetic operation section 72 and generate the display information based on the information stored in the template storage section 65, for example.

The display information generation section 73 outputs the generated display information to the display information storage section 66. Further, the display information storage section 73 outputs the generated display information to the user interface 50. Here, the nozzle deformation amount managing apparatus 18 described above can be configured by a computer device or the like, which includes an arithmetic device such as a CPU (Central Processing Unit), a storage device such as a ROM (Read Only Memory) or RAM (Random Access Memory), an external storage device such as a HDD (Hard Disk Drive) or CD (Compact Disc) drive device, a display device such as a display, an input device such as a keyboard or a mouse, and so on.

### (Arithmetic Operations in the Fixed-Cycle Deformation Amount Arithmetic Operation Section 71 and the Future Deformation Amount Arithmetic Operation Section 72)

Here, the flows of arithmetic operations in the fixed-cycle deformation amount arithmetic operation section 71 and the future deformation amount arithmetic operation section 72 are explained.

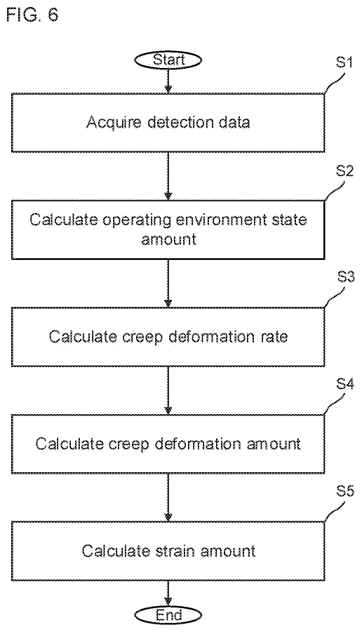

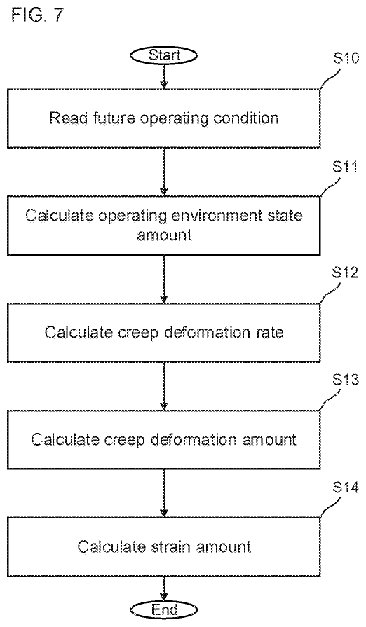

FIG. 6 is a flowchart for explaining the flow of arithmetic operation of the past creep deformation amount and the past strain amount in the fixed-cycle deformation amount arithmetic operation section 71 of the nozzle deformation amount managing apparatus 18 in the first embodiment. FIG. 7 is a flowchart for explaining the flow of arithmetic operation of the future creep deformation amount and the future strain amount in the future deformation amount arithmetic operation section 72 of the nozzle deformation amount managing apparatus 18 in the first embodiment.

Here, the arithmetic operation of the deformation amount related to the nozzle in the high-pressure turbine 11 is explained as an example, but the arithmetic operation of the deformation amount related to the nozzle in the intermediate-pressure turbine 13 is also executed in the same process.

First, referring to FIG. 6, the flow of the arithmetic operation of the past creep deformation amount and the past strain amount in the fixed-cycle deformation amount arithmetic operation section 71 is explained.

As illustrated in FIG. 6, the fixed-cycle deformation amount arithmetic operation section 71 reads information related to the measurement data from the measurement data storage section 62 (Step S1). Here, the fixed-cycle deformation amount arithmetic operation section 71 reads, as the information related to the measurement data, the steam temperature information and the steam pressure information at the inlet of the high-pressure turbine 11, the steam pressure information related to the rotor blade outlet pressure or the nozzle inlet pressure at the turbine stage of the first stage of the high-pressure turbine 11, and the electrical output information related to the electrical output of the generator 15. The information related to these measurement data functions as measured information for arithmetically operating the past creep deformation amount and the past strain amount.

Incidentally, when executing Step S1, the fixed-cycle deformation amount arithmetic operation section 71 has already read the program for executing the arithmetic operation of the past creep deformation amount and the past strain amount and the arithmetic expressions/equations and parameters for calculating the past creep deformation amount and the past strain amount from the program storage section 63, the design information of the nozzle to be managed from the input information storage section 61, and so on.

Then, the fixed-cycle deformation amount arithmetic operation section 71 calculates an operating environment state amount of the nozzle to be managed based on the information related to the read measurement data (Step S2). As the operating environment state amount, the steam pressure, steam flow rate, steam flow velocity, and steam temperature in the turbine stage provided with the nozzle to be managed are calculated.

Then, the fixed-cycle deformation amount arithmetic operation section 71 calculates a creep deformation rate V based on the calculated operating environment state amount and the design information of the nozzle to be managed (Step S3). Incidentally, the creep deformation rate V calculated here is the deformation rate of the component in the direction along the center axis of the turbine rotor of the high-pressure turbine 11.

Then, the fixed-cycle deformation amount arithmetic operation section 71 integrates the calculated creep deformation rate V over an operating time to calculate a creep deformation amount D that has progressed during the operating time (Step S4).

Here, the fixed-cycle deformation amount arithmetic operation section 71 calculates the past creep deformation amount by adding a creep deformation amount Di measured during a periodic inspection on a predetermined date in the past to the creep deformation amount D calculated by the above-described arithmetic operation. As a result, the past creep deformation amount that has reflected the operation of the high-pressure turbine 11 can be obtained.

Then, the fixed-cycle deformation amount arithmetic operation section 71 calculates the past strain amount by dividing the past creep deformation amount by a nozzle height (Step S5). Incidentally, the nozzle height is the height of the nozzle 153 in the radial direction perpendicular to the center axis of the turbine rotor 154 (see FIG. 2). In other words, the nozzle height corresponds to the distance between an inner wall surface of the diaphragm outer ring 151 on the radially inner side and an outer wall surface of the diaphragm inner ring 152 on the radially outer side (see FIG. 2).

Incidentally, the fixed-cycle deformation amount arithmetic operation section 71 outputs the arithmetic operation results to the arithmetic operation result storage section 64. The arithmetic operations of the past creep deformation amount and the past strain amount in the fixed-cycle deformation amount arithmetic operation section 71 described above are executed every hour, for example. The most recently calculated past creep deformation amount and past strain amount correspond to the present creep deformation amount and strain amount.

Next, referring to FIG. 7, the flow of the arithmetic operation of the future creep deformation amount and the future strain amount in the future deformation amount related information 72 is explained.

The arithmetic operation flow of the future deformation amount arithmetic operation section 72 is basically the same as that of the fixed-cycle deformation amount arithmetic operation section 71 except for Step S10 and Step S11 illustrated in FIG. 7. That is, pieces of the processing at Step S12 to Step S14 in the arithmetic operation by the future deformation amount arithmetic operation section 72 are basically the same as those at Step S3 to Step S5 in the arithmetic operation by the fixed-cycle deformation amount arithmetic operation section 71. Therefore, pieces of the processing at Step S10 and Step S11 in the arithmetic operation by the future deformation amount arithmetic operation section 72 are mainly explained.

As illustrated in FIG. 7, the future deformation amount arithmetic operation section 72 reads the future operating condition from the input information storage section 61 (Step S10). Incidentally, when executing Step S10, the future deformation amount arithmetic operation section 72 has already read the program for executing the arithmetic operation of the future creep deformation amount and the future strain amount and the arithmetic expressions/equations and parameters for calculating the future creep deformation amount and the future strain amount from the program storage section 63, the design information of the nozzle to be managed from the input information storage section 61, and so on.

Further, the future deformation amount arithmetic operation section 72 reads from the input information storage section 61 the steam temperature information and the steam pressure information at the inlet of the high-pressure turbine 11, the steam pressure information related to the nozzle inlet pressure and the nozzle outlet pressure of the nozzle to be managed in the high-pressure turbine 11, the steam temperature information related to the nozzle inlet temperature of the nozzle to be managed in the high-pressure turbine 11, and the electrical output information related to the electrical output of the generator 15, which are preset correspondingly to the classified loads, based on the future operating condition (Step S10). Incidentally, the steam temperature information, the steam pressure information, and the electrical output information that are read from the input information storage section 61 are handled in the same way as the steam temperature information and the steam pressure information at the inlet of the high-pressure turbine 11, the steam pressure information related to the rotor blade outlet pressure or the nozzle inlet pressure at the turbine stage of the first stage of the high-pressure turbine 11, and the electrical output information related to the electrical output of the generator 15 that are read from the measurement data storage section 62 in the previously-described arithmetic operation by the fixed-cycle deformation amount arithmetic operation section 71.

Then, the future deformation amount arithmetic operation section 72 calculates the operating environment state amount of the nozzle to be managed based on the steam temperature information, the steam pressure information, and the electrical output information, similarly to the arithmetic operation by the fixed-cycle deformation amount arithmetic operation section 71 (Step S11).

Then, the future deformation amount arithmetic operation section 72 executes pieces of the processing at Step S12 to Step S14 to calculate the creep deformation amount D that will progress during the operating time of the steam turbine facility (from the present to a predetermined date in the future). Incidentally, when calculating the creep deformation amount D at Step S13, the creep deformation rate V is integrated over the operating time from the present to a predetermined date in the future.

The future deformation amount arithmetic operation section 72 calculates the future creep deformation amount on the predetermined date in the future by adding the most recent past creep deformation amount calculated by the fixed-cycle deformation amount arithmetic operation section 71 to the calculated creep deformation amount D that will progress from the present to the predetermined date in the future. As a result, the future creep deformation amount that has reflected the future operation in the high-pressure turbine 11 can be obtained.

Incidentally, the future deformation amount arithmetic operation section 72 outputs the arithmetic operation results to the arithmetic operation result storage section 64. The arithmetic operation results of the future creep deformation amount and the future strain amount in the future deformation amount arithmetic operation section 72 described above are obtained for each one-year cycle set as the future operating condition. That is, the arithmetic operation results in the future deformation amount arithmetic operation section 72 are obtained in units of one year.

### (Calculations of the Recommended Replacement Time, the Recommended Inspection Time, the Recommended Preparation Time, and the Preparation Threshold)

Here, the method of calculating the recommended replacement time, the recommended inspection time, the recommended preparation time, and the preparation threshold is explained.

Incidentally, as described above, the recommended replacement time includes the recommended replacement time A and the recommended replacement time B, and the recommended inspection time includes the recommended inspection time A and the recommended inspection time B. The recommended replacement time and the recommended inspection time are calculated using the same method basically, and thus, the method of calculating the recommended replacement time A is explained as an example here.

Here, there is explained, as an example, the case where the recommended preparation time is calculated based on the recommended replacement time A. Further, there is explained, as an example, the case where the preparation period is set to 3 years here.

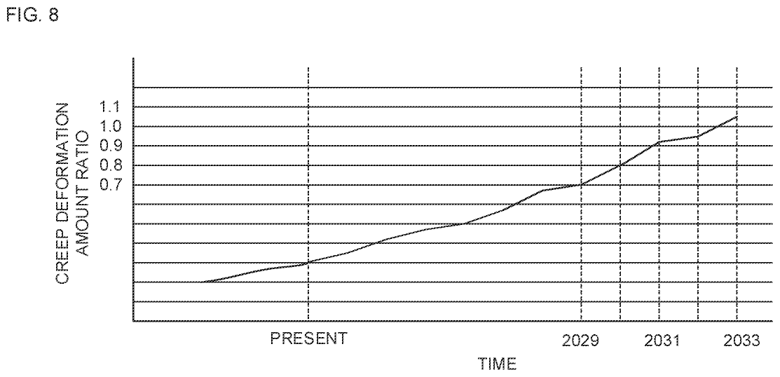

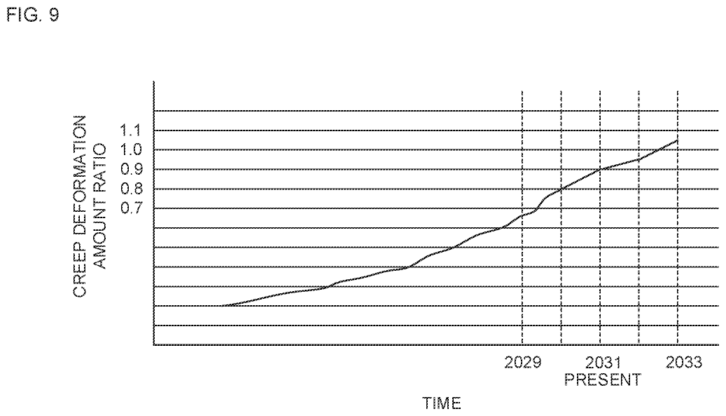

FIG. 8 and FIG. 9 are views for explaining the method of calculating the recommended replacement time A, the recommended preparation time, and the preparation threshold in the future deformation amount arithmetic operation section 72 of the nozzle deformation amount managing apparatus 18 in the first embodiment. In FIG. 8 and FIG. 9, the horizontal axis indicates a time (year), and the vertical axis indicates a creep deformation amount. Incidentally, the assumed month and day in each year on the horizontal axis is January 1 here.

Here, the creep deformation amount is described as a creep deformation amount ratio. The creep deformation amount ratio is the creep deformation amount ratio when the creep deformation amount at the replacement threshold A is set to 1. When the creep deformation amount ratio is smaller than 1.0, the creep deformation amount is below the replacement threshold A. When the creep deformation amount ratio is larger than 1.0, the creep deformation amount exceeds the replacement threshold A.

First, referring to FIG. 8, there is explained the case where the time when the creep deformation amount reaches the preparation threshold is the future.

As illustrated in FIG. 8, the creep deformation amount ratio in year 2032 is smaller than 1.0, and the creep deformation amount ratio in year 2033 is larger than 1.0. Therefore, the creep deformation amount ratio reaches 1.0, which is the replacement threshold A, during the period between year 2032 and year 2033. That is, the recommended replacement time A exists during the period between year 2032 and year 2033.

The future deformation amount arithmetic operation section 72 expresses the relationship between a time and a creep deformation amount ratio as a linear function during the period between year 2032 and year 2033. Then, the future deformation amount arithmetic operation section 72 calculates the month and day when the creep deformation amount ratio becomes 1.0.

In the example illustrated in FIG. 8, the creep deformation amount ratio in year 2032 is 0.95, and the creep deformation amount ratio in year 2033 is 1.05. The future deformation amount arithmetic operation section 72 calculates the recommended replacement time A when the creep deformation amount ratio becomes 1.0 based on the linear function. In the example illustrated in FIG. 8, as a result of the arithmetic operation, Jul. 1, 2032 is the recommended replacement time A.

Then, the future deformation amount arithmetic operation section 72 calculates the recommended preparation time based on the recommended replacement time A and the preparation period. Here, when the preparation period is set to 3 years, the recommended preparation time is Jul. 1, 2029, which is 3 years before the recommended replacement time A.

Then, the future deformation amount arithmetic operation section 72 expresses the relationship between a time and a creep deformation amount ratio as a linear function during the period between year 2029 and year 2030. Then, the future deformation amount arithmetic operation section 72 calculates the creep deformation amount ratio on Jul. 1, 2029. In the example illustrated in FIG. 8, as a result of the arithmetic operation, the creep deformation amount ratio on Jul. 1, 2029 is 0.75. This result reveals that the preparation threshold, which is the creep deformation amount ratio at the recommended preparation time, is 0.75.

Then, the future deformation amount arithmetic operation section 72 outputs the above-described arithmetic operation results of the recommended replacement time A, the recommended preparation time, and the preparation threshold to the arithmetic operation result storage section 64. The arithmetic operation result storage section 64 receives and stores the arithmetic operation results of the recommended replacement time A, the recommended preparation time, and the preparation threshold.

Next, referring to FIG. 9, there is explained the case where the time when the creep deformation amount reaches the preparation threshold is the past.

As illustrated in FIG. 9, the creep deformation amount ratio reaches 1.0 during the period between year 2032 and year 2033. That is, the recommended replacement time A exists during the period between year 2032 and year 2033. Therefore, the recommended preparation time exists in the past rather than at present (year 2031).

As illustrated in FIG. 9, as in the explanation with reference to FIG. 8, the future deformation amount arithmetic operation section 72 calculates the month and day when the creep deformation amount ratio is 1.0 by expressing the relationship between a time and a creep deformation amount ratio as a linear function during the period between year 2032 and year 2033.

In the example illustrated in FIG. 9, the creep deformation amount ratio in year 2032 is 0.95, and the creep deformation amount ratio in year 2033 is 1.05. In the example illustrated in FIG. 9, as a result of the arithmetic operation, Jul. 1, 2032 is the recommended replacement time A.

Then, the future deformation amount arithmetic operation section 72 calculates the recommended preparation time based on the recommended replacement time A and the preparation period. Here, when the preparation period is set to 3 years, the recommended preparation time is Jul. 1, 2029, which is 3 years before the recommended replacement time A.

Then, the future deformation amount arithmetic operation section 72 reads the creep deformation amount on Jul. 1, 2029 from the arithmetic operation result storage section 64 and calculates the creep deformation amount ratio. This calculated creep deformation amount ratio is the preparation threshold.

Here, the creep deformation amount on Jul. 1, 2029 is the result of the arithmetic operation by the fixed-cycle deformation amount arithmetic operation section 71. Therefore, the arithmetic operation result storage section 64 has stored a plurality of data every hour as the arithmetic operation result for this day. Thus, as the creep deformation amount on Jul. 1, 2029, the future deformation amount arithmetic operation section 72 refers to the largest creep deformation amount in pieces of the data of the creep deformation amount on Jul. 1, 2029, for example.

Then, the future deformation amount arithmetic operation section 72 outputs the above-described arithmetic operation results of the recommended replacement time A, the recommended preparation time, and the preparation threshold to the arithmetic operation result storage section 64. The arithmetic operation result storage section 64 receives and stores the arithmetic operation results of the recommended replacement time A, the recommended preparation time, and the preparation threshold.

Here, as a result of the arithmetic operation of the future creep deformation amount, when the creep deformation amount ratio does not reach 1.0 during a specified future arithmetic operation period, the recommended replacement time A, the recommended preparation time, and the preparation threshold are not obtained.

### (Regarding the Nozzle Deformation Amount Managing Apparatus 18 at the Time of Installation)

Here, the state of the nozzle deformation amount managing apparatus 18 at the time of installation is first explained.

At the time of installation of the nozzle deformation amount managing apparatus 18, the display information storage section 66 has stored display information on the past creep deformation amount and the future creep deformation amount and display information on the past strain amount and the future strain amount as of the date of installation. That is, at the time of installation, the nozzle deformation amount managing apparatus 18 is in a state of being capable of displaying the past creep deformation amount, the future creep deformation amount, the past strain amount, and the future strain amount as of the date of installation on the display part of the user interface 50.

The display information storage section 66 has stored the display information as of the date of installation generated by the display information generation section 73 based on the arithmetic operation results obtained by arithmetic operations by the fixed-cycle deformation amount arithmetic operation section 71 and the future deformation amount arithmetic operation section 72 stored in the arithmetic operation result storage section 64 and the information related to the template screens stored in the template storage section 65.

Incidentally, the manufacturer has processed the nozzle deformation amount managing apparatus 18 so as to bring it into the above-described state as of the date of installation.

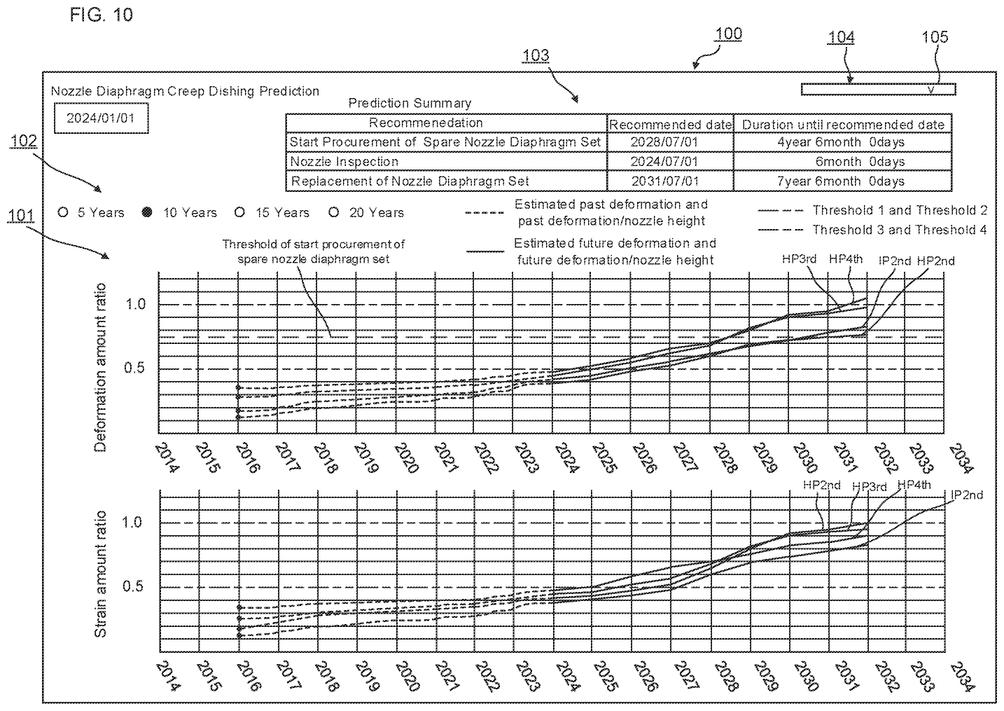

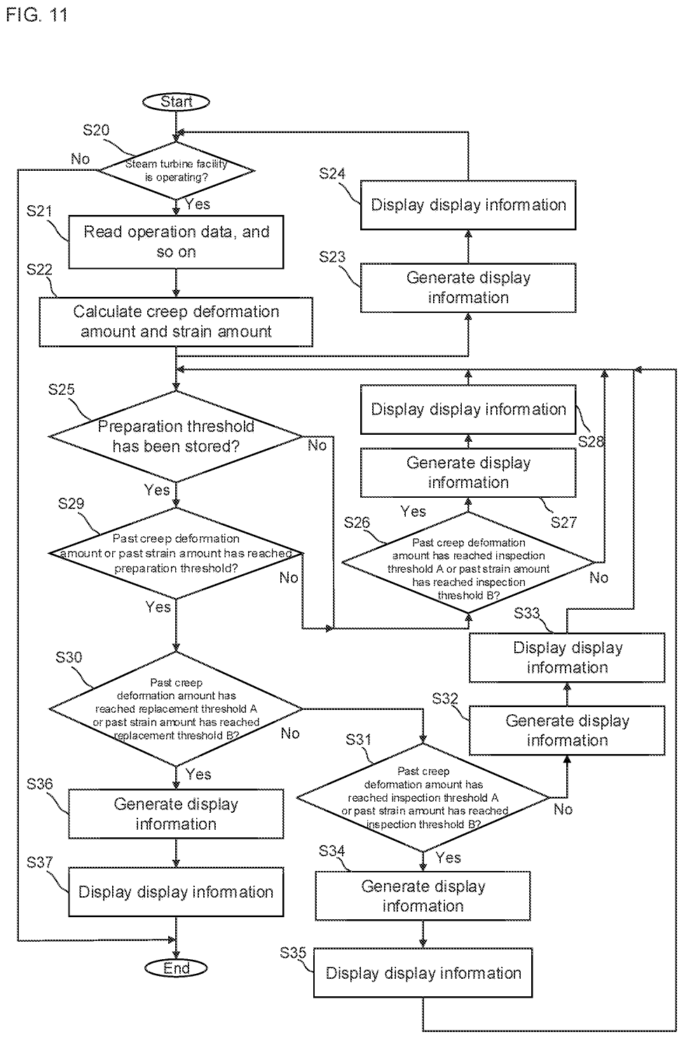

Here, FIG. 10 is a view illustrating one example of the display screen 100 on which the display information was displayed as of the date of installation of the nozzle deformation amount managing apparatus 18 in the first embodiment.

As illustrated in FIG. 10, on the display screen 100, the past creep deformation amount, the future creep deformation amount, the past strain amount, and the future strain amount in the nozzles of the turbine stages of the second stage to the fourth stage of the high-pressure turbine 11 and the nozzle of the turbine stage of the second stage of the intermediate-pressure turbine 13 are illustrated in chronological order. Incidentally, here, the turbine type and the turbine stage are displayed via leader lines in a graph 101 due to the line display relationship, but the present invention is not limited to the display method. The lines indicating the results in the graph 101 may be displayed in different colors for each turbine type and turbine stage. In this case, an index for each line color is displayed on the display screen 100. Further, in the graph 101, although the preparation threshold is displayed via a leader line, an index for the line indicating the preparation threshold may be displayed.

In the graph 101 illustrating the results of the creep deformation amounts and the strain amounts, the horizontal axis indicates a time (year, month, and day), and the vertical axis indicates a creep deformation amount ratio and a strain amount ratio. Incidentally, Jan. 1, 2024 is set as the present here. Here, the creep deformation amount is illustrated as the creep deformation amount ratio, and the strain amount is illustrated as the strain amount ratio. On the display screen 100, the creep deformation amount ratio is a creep deformation amount ratio when the creep deformation amount at the inspection threshold A is set to 1. Further, the strain amount ratio is a strain amount ratio when the strain amount at the inspection threshold B is set to 1.

FIG. 10 illustrates a time axis from Jan. 1, 2014 to Jan. 1, 2034. The range of this time axis is set by selecting a set value of a time axis setting portion 102 on the display screen 100. There is illustrated one example here in which 5 years, 10 years, 15 years, and 20 years are set as the set value of the time axis setting portion 102. Incidentally, in FIG. 10, the set value of 10 years has been selected.

The time axis indicates the past for the set value from the present and the future for the set value from the present. For example, when the set value of 10 years is selected as illustrated in FIG. 10, the time range for the past 10 years from the present (Jan. 1, 2024) to Jan. 1, 2014 and the time range for the future 10 years from the present (Jan. 1, 2024) to Jan. 1, 2034 are displayed as the time axis.

Thus, the user can arbitrarily change the range of the time axis by selecting the set value in the time axis setting portion 102.

Incidentally, in FIG. 10, the arithmetic operation results from Jan. 1, 2016 to Jan. 1, 2032 have been illustrated as the creep deformation amount and the strain amount. In this case, the creep deformation amount ratios and the strain amount ratios from Jan. 1, 2016 to Jan. 1, 2024 are the creep deformation amount ratio and the strain amount ratio based on the past creep deformation amount and the past strain amount. Further, the creep deformation amount ratios and the strain amount ratios from Jan. 1, 2024 to Jan. 1, 2032 are the creep deformation amount ratio and the strain amount ratio based on the future creep deformation amount and the future strain amount.

Here, the creep deformation amount ratio and the strain amount ratio on Jan. 1, 2016 have been illustrated based on the periodic inspection results input from the input screen 90 illustrated in FIG. 5. In the graph 101 on the display screen 100, the creep deformation amount ratio and the strain amount ratio based on the periodic inspection results have been illustrated by a black circle. Incidentally, even in the case where there are arithmetic operation results prior to the latest periodic inspection, for example, the arithmetic operation results of and after the latest periodic inspection are displayed on the display screen 100, and the arithmetic operation results prior to the latest periodic inspection are not displayed.

Further, on the display screen 100, the replacement threshold A has been illustrated as “Threshold 1,” the replacement threshold B has been illustrated as “Threshold 2,” the inspection threshold A has been illustrated as “Threshold 3,” and the inspection threshold B has been illustrated as “Threshold 4.” Incidentally, on the display screen 100, the preparation threshold has also been illustrated.

Incidentally, the replacement threshold A, the replacement threshold B, the inspection threshold A, and the inspection threshold B are default values stored in the input information storage section 61 as initial values, and thus “Threshold 1” to “Threshold 4” have always been displayed on the display screen 100.

An alarm display 103 is displayed on the display screen 100. The alarm display 103 is displayed when the creep deformation amount exceeds the replacement threshold A or the inspection threshold A, and when the strain amount exceeds the replacement threshold B or the inspection threshold B. When these cases are not applied, the alarm display 103 is not displayed on the display screen 100.

As the alarm display 103, for example, the recommended replacement time based on the replacement threshold that the creep deformation amount or the strain amount reached first out of the replacement threshold A and the replacement threshold B is illustrated. Further, as the alarm display 103, for example, the recommended inspection time based on the inspection threshold that the creep deformation amount or the strain amount reached first out of the inspection threshold A and the inspection threshold B is illustrated. Further, on the alarm display 103, the recommended preparation time may be illustrated. Further, as in the example illustrated in FIG. 10, the year, month, and day from the present to each recommended time may be illustrated.

As illustrated in FIG. 10, on the display screen 100 of the user interface 50, variations in the past and future creep deformation amounts and the past and future strain amounts over time are displayed on the single graph 101. Further, the recommended replacement time A or the recommended replacement time B, the recommended inspection time A or the recommended inspection time B, and the recommended preparation time are displayed on the display screen 100.

### (Fixed-Cycle Deformation Amount Arithmetic Operation Processing)

Next, there is explained arithmetic operation processing of the past creep deformation amount and the past strain amount in the nozzle deformation amount managing apparatus 18 in the first embodiment.

FIG. 11 is a flowchart for explaining a method of the arithmetic operation processing of the past creep deformation amount and the past strain amount in the nozzle deformation amount managing apparatus 18 in the first embodiment.

Incidentally, the fixed-cycle deformation amount arithmetic operation section 71 executes arithmetic operation processing for each of the nozzles to be managed. The arithmetic operation processing method is the same for all nozzles.

Here, the fixed-cycle deformation amount arithmetic operation processing related to the nozzle at a predetermined turbine stage in the high-pressure turbine 11 is explained as an example, but the same arithmetic operation processing is also executed for fixed-cycle deformation amount arithmetic operation processing related to the nozzle in the intermediate-pressure turbine 13.

As illustrated in FIG. 11, the fixed-cycle deformation amount arithmetic operation section 71 determines whether or not the steam turbine facility 1 is operating based on the information stored in the measurement data storage section 62, for example (Step S20). The fixed-cycle deformation amount arithmetic operation section 71 determines whether or not the steam turbine facility 1 is operating based on, for example, the steam temperature information, the steam pressure information, and the electrical output information.

When determining in the determination of Step S20 that the steam turbine facility 1 is not operating (No at Step S20), the fixed-cycle deformation amount arithmetic operation section 71 finishes the fixed-cycle deformation amount arithmetic operation processing.

When determining in the determination of Step S20 that the steam turbine facility is operating (Yes at Step S20), the fixed-cycle deformation amount arithmetic operation section 71 reads the program for executing the arithmetic operation of the past creep deformation amount and the past strain amount and the arithmetic expressions/equations and parameters for calculating the past creep deformation amount and the past strain amount from the program storage section 63, the design information of the nozzle to be managed from the input information storage section 61, and the measurement data information stored in the measurement data storage section 62 (Step S21). Incidentally, the measurement data information is the steam temperature information and the steam pressure information at the inlet of the high-pressure turbine 11, the steam pressure information related to the rotor blade outlet pressure or the nozzle inlet pressure at the turbine stage of the first stage of the high-pressure turbine 11, and the electrical output information related to the electrical output of the generator 15.

Then, the fixed-cycle deformation amount arithmetic operation section 71 arithmetically operates the past creep deformation amount and the past strain amount using the arithmetic operation method explained with reference to FIG. 6, and outputs the arithmetic operation results to the arithmetic operation result storage section 64 (Step S22). The arithmetic operation result storage section 64 stores the arithmetic operation results.

The display information generation section 73 generates display information based on the arithmetic operation results stored in the arithmetic operation result storage section 64 and the information stored in the template storage section 65 (Step S23). Then, the display information generation section 73 outputs the generated display information to the display information storage section 66 and the user interface 50. The display information storage section 66 stores the display information.

The user interface 50 displays the display information output from the display information generation section 73 on the display part as illustrated in FIG. 10 (Step S24).

Here, the display information generation section 73 outputs the display information based on the arithmetic operation results to the display information storage section 66 and the user interface 50 every hour. Therefore, the graph 101 illustrating the arithmetic operation results regarding the past creep deformation amount and the past strain amount displayed on the display part is updated every hour. For example, after arithmetically operating the past creep deformation amount and the past strain amount, the fixed-cycle deformation amount arithmetic operation section 71 performs pieces of the processing at Step S20 to Step S24 repeatedly every hour.

Further, after the processing at Step S22, the fixed-cycle deformation amount arithmetic operation section 71 refers to the arithmetic operation result storage section 64 to determine whether or not the preparation threshold has been stored (Step S25).

Here, for example, in the case where the future creep deformation amount has reached the replacement threshold A or the future strain amount has reached the replacement threshold B within the specified future arithmetic operation period in the arithmetic operations of the future creep deformation amount and the future strain amount as of the date of installation of the nozzle deformation amount managing apparatus 18, the preparation threshold has been stored in the arithmetic operation result storage section 64. Further, in the case where the future creep deformation amount has reached the replacement threshold A or the future strain amount has reached the replacement threshold B within the specified future arithmetic operation period in the arithmetic operations after the installation of the nozzle deformation amount managing apparatus 18, the preparation threshold has been stored in the arithmetic operation result storage section 64.

On the other hand, in the case where the future creep deformation amount has not reached the replacement threshold A or the future strain amount has not reached the replacement threshold B within the specified future arithmetic operation period in the arithmetic operations of the future creep deformation amount and the future strain amount as of the date of installation of the nozzle deformation amount managing apparatus 18, the preparation threshold has not been stored in the arithmetic operation result storage section 64. Further, in the case where the future creep deformation amount has not reached the replacement threshold A or the future strain amount has not reached the replacement threshold B within the specified future arithmetic operation period in the arithmetic operations after the installation of the nozzle deformation amount managing apparatus 18, the preparation threshold has not been stored in the arithmetic operation result storage section 64.

When determining in the determination of Step S25 that the preparation threshold has not been stored (No at Step S25), the fixed-cycle deformation amount arithmetic operation section 71 determines whether or not the past creep deformation amount has reached the inspection threshold A or the past strain amount has reached the inspection threshold B based on the arithmetic operation results at Step S22 (Step S26).

When determining in the determination of Step S26 that the past creep deformation amount has not reached the inspection threshold A or the past strain amount has not reached the inspection threshold B (No at Step S26), the fixed-cycle deformation amount arithmetic operation section 71 executes the processing at Step S25 again.

When determining in the determination of Step S26 that the past creep deformation amount has reached the inspection threshold A or the past strain amount has reached the inspection threshold B (Yes at Step S26), the fixed-cycle deformation amount arithmetic operation section 71 outputs information on the year, month, and day when the past creep deformation amount reached the inspection threshold A or the past strain amount reached the inspection threshold B (information related to the recommended inspection time) to the arithmetic operation result storage section 64. The arithmetic operation result storage section 64 stores this information.

The display information generation section 73 generates display information based on the arithmetic operation results stored in the arithmetic operation result storage section 64 and the information stored in the template storage section 65 (Step S27). Then, the display information generation section 73 outputs the generated display information to the display information storage section 66 and the user interface 50. The display information storage section 66 stores the display information.

The user interface 50 updates the display screen based on the display information output from the display information generation section 73 (Step S28). By this update, the information on the recommended inspection time is displayed on the alarm display 103 illustrated in FIG. 10. Incidentally, after executing Step S28, the fixed-cycle deformation amount arithmetic operation section 71 executes the processing at Step S25 again.

When determining in the determination of Step 25 that the preparation threshold has been stored (Yes at Step S25), the fixed-cycle deformation amount arithmetic operation section 71 determines whether or not the past creep deformation amount or the past strain amount has reached the preparation threshold based on the arithmetic operation results at Step S22 (Step S29).

Here, the case where the past creep deformation amount or the past strain amount reaches the preparation threshold means that the past creep deformation amount or the past strain amount reaches the preparation threshold based on the future prediction calculated by the future deformation amount arithmetic operation section 72.

When determining in the determination of Step S29 that the past creep deformation amount or the past strain amount has not reached the preparation threshold (No at Step S29), the fixed-cycle deformation amount arithmetic operation section 71 executes pieces of the above-described processing from Step S26.

When determining in the determination of Step 29 that the past creep deformation amount or the past strain amount has reached the preparation threshold (Yes at Step S29), the fixed-cycle deformation amount arithmetic operation section 71 determines whether or not the past creep deformation amount has reached the replacement threshold A or the past strain amount has reached the replacement threshold B (Step S30).

When determining in the determination of Step 30 that the past creep deformation amount has not reached the replacement threshold A or the past strain amount has not reached the replacement threshold B (No at Step S30), the fixed-cycle deformation amount arithmetic operation section 71 determines whether or not the past creep deformation amount has reached the inspection threshold A or the past strain amount has reached the inspection threshold B (Step S31).

When determining in the determination of Step S31 that the past creep deformation amount has not reached the inspection threshold A or the past strain amount has not reached the inspection threshold B (No at Step S31), the fixed-cycle deformation amount arithmetic operation section 71 outputs information on the year, month, and day when the past creep deformation amount or the past strain amount reached the preparation threshold (information related to the recommended preparation time) to the arithmetic operation result storage section 64. The arithmetic operation result storage section 64 stores this information.

The display information generation section 73 generates display information based on the arithmetic operation results stored in the arithmetic operation result storage section 64 and the information stored in the template storage section 65 (Step S32). Then, the display information generation section 73 outputs the generated display information to the display information storage section 66 and the user interface 50. The display information storage section 66 stores the display information.

The user interface 50 updates the display screen based on the display information output from the display information generation section 73 (Step S33). By this update, the information on the recommended preparation time is displayed on the alarm display 103 illustrated in FIG. 10. Incidentally, after executing Step S33, the fixed-cycle deformation amount arithmetic operation section 71 executes the processing at Step S25 again.

When determining in the determination of Step S31 that the past creep deformation amount has reached the inspection threshold A or the past strain amount has reached the inspection threshold B (Yes at Step S31), the fixed-cycle deformation amount arithmetic operation section 71 outputs information on the year, month, and day when the past creep deformation amount reached the inspection threshold A or the past strain amount reached the inspection threshold B and the past creep deformation amount or the past strain amount reached the preparation threshold (information related to the recommended inspection time A or the recommended inspection time B and the recommended preparation time) to the arithmetic operation result storage section 64. The arithmetic operation result storage section 64 stores this information.

The display information generation section 73 generates display information based on the arithmetic operation results stored in the arithmetic operation result storage section 64 and the information stored in the template storage section 65 (Step S34). Then, the display information generation section 73 outputs the generated display information to the display information storage section 66 and the user interface 50. The display information storage section 66 stores the display information.

The user interface 50 updates the display screen based on the display information output from the display information generation section 73 (Step S35). By this update, the information on the recommended inspection time A or the recommended inspection time B and the recommended preparation time is displayed on the alarm display 103 illustrated in FIG. 10. Incidentally, after executing Step S35, the fixed-cycle deformation amount arithmetic operation section 71 executes the processing at Step S25 again.

When determining in the determination of Step S30 that the past creep deformation amount has reached the replacement threshold A or the past strain amount has reached the replacement threshold B (Yes at Step S30), the fixed-cycle deformation amount arithmetic operation section 71 outputs information on the year, month, and day when the past creep deformation amount reached the replacement threshold A or the past strain amount reached the replacement threshold B, the past creep deformation amount reached the inspection threshold A or the past strain amount reached the inspection threshold B, and the past creep deformation amount or the past strain amount reached the preparation threshold (information related to the recommended replacement time A or the recommended replacement time B, the recommended inspection time A or the recommended inspection time B, and the recommended preparation time) to the arithmetic operation result storage section 64. The arithmetic operation result storage section 64 stores this information.

The display information generation section 73 generates display information based on the arithmetic operation results stored in the arithmetic operation result storage section 64 and the information stored in the template storage section 65 (Step S36). Then, the display information generation section 73 outputs the generated display information to the display information storage section 66 and the user interface 50. The display information storage section 66 stores the display information.

The user interface 50 updates the display screen based on the display information output from the display information generation section 73 (Step S37). By this update, the information on the recommended replacement time A or the recommended replacement time B, the recommended inspection time A or the recommended inspection time B, and the recommended preparation time is displayed on the alarm display 103 illustrated in FIG. 10.

Here, the arithmetic operation in the fixed-cycle deformation amount arithmetic operation section 71 is executed, for example, every hour. Therefore, the information on the past creep deformation amount and the past strain amount on the display screen 100 is updated every hour. Incidentally, when the time range on the horizontal axis is the same, the information on the past creep deformation amount and the past strain amount in the graph 101 in FIG. 10 increases with the passage of time.

By the fixed-cycle deformation amount arithmetic operation processing described above, the information on the past creep deformation amount and the past strain amount on the display screen 100 illustrated in FIG. 10 is updated. Further, when the past creep deformation amount and the past strain amount have reached the respective set thresholds, the information on the alarm display 103 is updated.

### (Future Deformation Amount Arithmetic Operation Processing)

Next, there is explained arithmetic operation processing of the future creep deformation amount and the future strain amount in the nozzle deformation amount managing apparatus 18 in the first embodiment.

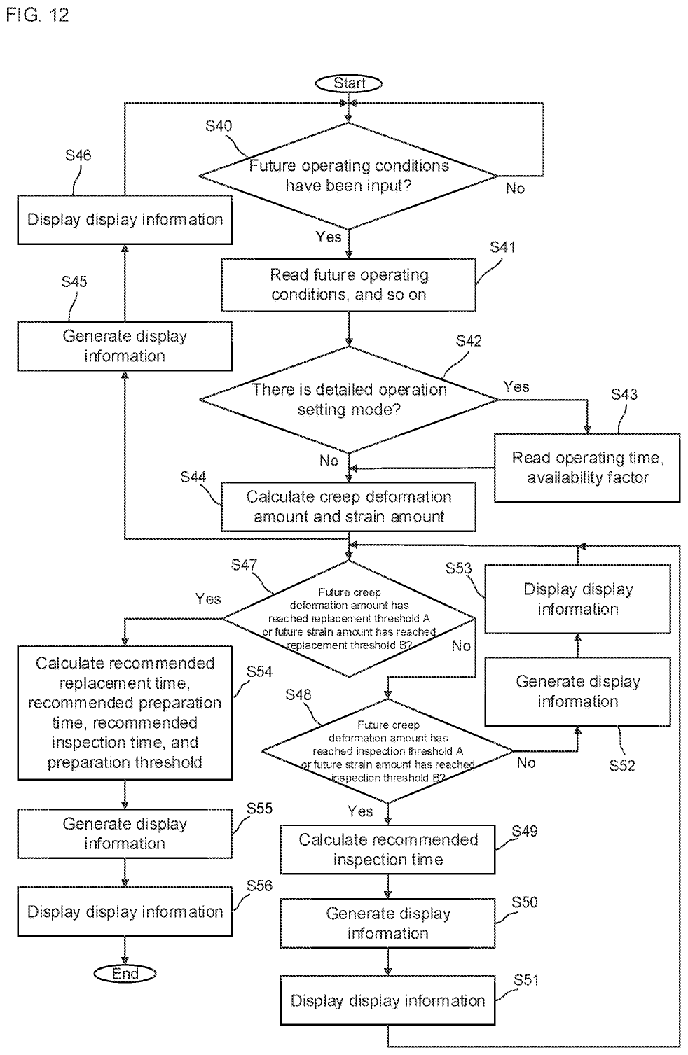

FIG. 12 is a flowchart for explaining a method of the arithmetic operation processing of the future creep deformation amount and the future strain amount in the nozzle deformation amount managing apparatus 18 in the first embodiment.

Incidentally, the future deformation amount arithmetic operation section 72 executes arithmetic operation processing for each of the nozzles to be managed. The arithmetic operation processing method is the same for all nozzles.

Here, the future deformation amount arithmetic operation processing related to the nozzle at a predetermined turbine stage in the high-pressure turbine 11 is explained as an example, but the same arithmetic operation processing is also executed for future deformation amount arithmetic operation processing related to the nozzle in the intermediate-pressure turbine 13.

Here, as of the date of installation of the nozzle deformation amount managing apparatus 18, the future operating conditions illustrated in FIG. 4 have been set initially. After the installation, the user inputs the future operating conditions in units of one year via the input screen 80 illustrated in FIG. 4 in the user interface 50.

For example, by pressing a selection button 105 in a selection display portion 104 on the display screen 100 illustrated in FIG. 10, a selection item of the input screen 80 for future operating conditions is displayed in the selection display portion 104, although not illustrated. When the selection item of the input screen 80 is selected in the selection display portion 104, the screen of the display part of the user interface 50 is switched to the input screen 80 for future operating conditions illustrated in FIG. 4. At this time, the display information generation section 73 receives information related to the selection of the input screen 80 from the user interface 50 and outputs display information for displaying the input screen 80 to the user interface 50.

Then, after inputting the future operating conditions, the user presses the Save button 87 in FIG. 4. The user interface 50 receives input from the Save button 87 and outputs information related to the future operating conditions to the input information storage section 61. The input information storage section 61 stores the information related to the future operating conditions. Incidentally, the Back button 88 on the input screen 80 is a button to be pressed when returning to the display screen 100 without pressing the Save button 87.

Further, the future deformation amount arithmetic operation section 72 receives information from the user interface 50 in response to the press of the Save button 87, and determines that the future operating conditions have been input.

As illustrated in FIG. 12, the future deformation amount arithmetic operation section 72 determines whether or not the future operating conditions have been input (Step S40).

When determining in the determination of Step S40 that the future operating conditions have not been input (No at Step S40), the future deformation amount arithmetic operation section 72 executes the processing at Step S40 again.

When determining in the determination of Step S40 that the future operating conditions have been input (Yes at Step S40), the future deformation amount arithmetic operation section 72 reads the program for executing the arithmetic operation of the future creep deformation amount and the future strain amount and the arithmetic expressions/equations and parameters for calculating the future creep deformation amount and the future strain amount from the program storage section 63, the design information of the nozzle to be managed from the input information storage section 61, and the future operating conditions stored in the input information storage section 61 (Step S41).

Then, the future deformation amount arithmetic operation section 72 refers to the future operating conditions to determine whether or not there is the detailed operation setting mode (Step S42).

When determining in the determination of Step S42 that there is the detailed operation setting mode (Yes at Step S42), the future deformation amount arithmetic operation section 72 reads the operating time for each classified load under the future operating conditions and the availability factor (Step S43).

Then, after the processing at Step S43, or when determining in the determination of Step S42 that there is not the detailed operation setting mode (No at Step S42), the future deformation amount arithmetic operation section 72 arithmetically operates the future creep deformation amount and the future strain amount using the arithmetic operation method explained with reference to FIG. 7 and outputs the arithmetic operation results to the arithmetic operation result storage section 64 (Step S44). The arithmetic operation result storage section 64 stores the arithmetic operation results.

The display information generation section 73 generates display information based on the arithmetic operation results stored in the arithmetic operation result storage section 64 and the information stored in the template storage section 65 (Step S45). Then, the display information generation section 73 outputs the generated display information to the display information storage section 66 and the user interface 50. The display information storage section 66 stores the display information.

The user interface 50 displays the display information output from the display information generation section 73 on the display part as illustrated in FIG. 9 (Step S46).

Here, the display information generation section 73 outputs the display information based on the arithmetic operation results to the display information storage section 66 and the user interface 50 each time the arithmetic operation processing is executed by the future deformation amount arithmetic operation section 72. Therefore, the graph 101 illustrating the arithmetic operation results regarding the future creep deformation amount and the future strain amount displayed on the display part is updated each time the arithmetic operation processing is executed in the future deformation amount arithmetic operation section 72. In other words, the graph 101 illustrating the arithmetic operation results regarding the future creep deformation amount and the future strain amount is updated each time the information in response to the press of the Save button 87 on the input screen 80 for future operating conditions is received.

Further, after the processing at Step S44, the future deformation amount arithmetic operation section 72 determines whether or not the future creep deformation amount has reached the replacement threshold A or the future strain amount has reached the replacement threshold B based on the arithmetic operation results at Step S44 (Step S47).

When determining in the determination of Step S47 that the future creep deformation amount has not reached the replacement threshold A or the future strain amount has not reached the replacement threshold B (No at Step S47), the future deformation amount arithmetic operation section 72 determines whether or not the future creep deformation amount has reached the inspection threshold A or the future strain amount has reached the inspection threshold B (Step S48).

When determining in the determination of Step S48 that the future creep deformation amount has not reached the inspection threshold A or the future strain amount has not reached the inspection threshold B (No at Step S48), the future deformation amount arithmetic operation section 72 outputs information on the recommended replacement time A or the recommended replacement time B and the recommended inspection time A or the recommended inspection time B to the arithmetic operation result storage section 64. That is, the future deformation amount arithmetic operation section 72 outputs information on the fact that there is not the recommended replacement time A or the recommended replacement time B and there is not the recommended inspection time A or the recommended inspection time B to the arithmetic operation result storage section 64. Here, in the case where the recommended replacement time A or the recommended replacement time B and the recommended inspection time A or the recommended inspection time B have already been stored in the arithmetic operation result storage section 64, the arithmetic operation result storage section 64 updates the information on the above to the newly input information on the fact that there is not the recommended replacement time A or the recommended replacement time B and there is not the recommended inspection time A or the recommended inspection time B and stores the updated information.

The display information generation section 73 generates display information based on the arithmetic operation results stored in the arithmetic operation result storage section 64 and the information stored in the template storage section 65 (Step S52). The display information generation section 73 generates display information in which the alarm display 103 has been deleted from the display screen 100 illustrated in FIG. 10. Further, the display information generation section 73 generates display information in which the line indicating the preparation threshold (dotted line in FIG. 10) has been deleted from the graph 101 on the display screen 100 illustrated in FIG. 10.

Then, the display information generation section 73 outputs the generated display information to the display information storage section 66 and the user interface 50. The display information storage section 66 stores the display information.

The user interface 50 updates the display screen based on the display information output from the display information generation section 73 (Step S53). By this update, the alarm display 103 is deleted from the display screen 100. Further, the line indicating the preparation threshold (dotted line in FIG. 10) is deleted from the graph 101.

When determining in the determination of Step S48 that the future creep deformation amount has reached the inspection threshold A or the future strain amount has reached the inspection threshold B (Yes at Step S48), the future deformation amount arithmetic operation section 72 calculates the recommended inspection time by the method explained with reference to FIG. 8 and FIG. 9, and outputs the calculated result to the arithmetic operation result storage section 64 (Step S49). The arithmetic operation result storage section 64 stores the recommended inspection time. Further, the future deformation amount arithmetic operation section 72 outputs the information on the fact that there is not the recommended replacement time A or the recommended replacement time B to the arithmetic operation result storage section 64.

The display information generation section 73 generates display information based on the arithmetic operation results stored in the arithmetic operation result storage section 64 and the information stored in the template storage section 65 (Step S50). The display information generation section 73 displays the recommended inspection time A or the recommended inspection time B on the alarm display 103 on the display screen 100 illustrated in FIG. 10, and generates display information for deleting the recommended replacement time A or the recommended replacement time B. Further, the display information generation section 73 generates display information for deleting the line indicating the preparation threshold (dotted line in FIG. 10) from the graph 101.

Then, the display information generation section 73 outputs the generated display information to the display information storage section 66 and the user interface 50. The display information storage section 66 stores the display information.

The user interface 50 updates the display screen based on the display information output from the display information generation section 73 (Step S51). By this update, the alarm display 103 including the recommended inspection time A or the recommended inspection time B based on the current calculation result is displayed on the display screen 100. Incidentally, the line indicating the preparation threshold is not illustrated in the graph 101.

When determining in the determination of Step S47 that the future creep deformation amount has reached the replacement threshold A or the future strain amount has reached the replacement threshold B (Yes at Step S47), the future deformation amount arithmetic operation section 72 calculates the recommended replacement time A or the recommended replacement time B and the recommended inspection time A or the recommended inspection time B by the method explained with reference to FIG. 8 and FIG. 9, and at the same time, calculates the recommended preparation time and the preparation threshold (Step S54). And then, the future deformation amount arithmetic operation section 72 outputs the results to the arithmetic operation result storage section 64 (Step S54). The arithmetic operation result storage section 64 stores the recommended replacement time A or the recommended replacement time B, the recommended inspection time A or the recommended inspection time B, the recommended preparation time, and the preparation threshold. Incidentally, in the case where the arithmetic operation result has reached the replacement threshold A or the replacement threshold B, the arithmetic operation result has reached the inspection threshold A or the inspection threshold B.

The display information generation section 73 generates display information based on the arithmetic operation results stored in the arithmetic operation result storage section 64 and the information stored in the template storage section 65 (Step S55). The display information generation section 73 generates display information for displaying the recommended replacement time A or the recommended replacement time B, the recommended inspection time A or the recommended inspection time B, and the recommended preparation time on the alarm display 103 on the display screen 100 illustrated in FIG. 10. Further, the display information generation section 73 generates display information for displaying the line of the preparation threshold (dotted line in FIG. 10) in the graph 101.

Then, the display information generation section 73 outputs the generated display information to the display information storage section 66 and the user interface 50. The display information storage section 66 stores the display information.

The user interface 50 updates the display screen based on the display information output from the display information generation section 73 (Step S56). By this update, the alarm display 103 including the recommended replacement time A or the recommended replacement time B, the recommended inspection time A or the recommended inspection time B, and the recommended preparation time based on the current calculation result is displayed on the display screen 100. Incidentally, the line indicating the preparation threshold (dotted line in FIG. 10) based on the current calculation result is illustrated in the graph 101.

The arithmetic operation results in the future deformation amount arithmetic operation section 72 described above are obtained for each one-year cycle set as the future operating condition. That is, the arithmetic operation results in the future deformation amount arithmetic operation section 72 are obtained in units of one year.

In the future deformation amount arithmetic operation processing, pieces of the processing at Step S41 to Step S56 are performed repeatedly each time the information in response to the press of the Save button 87 on the input screen 80 for future operating conditions is received. Then, the information on the future creep deformation amount and the future strain amount on the display screen 100 is updated each time the information in response to the press of the Save button 87 on the input screen 80 for future operating conditions is received.

By the future deformation amount arithmetic operation processing described above, the information on the future creep deformation amount and the future strain amount on the display screen 100 illustrated in FIG. 10 is updated. For example, the information on the future creep deformation amount and the future strain amount illustrated in the graph 101 varies depending on the future operating condition. Further, the recommended replacement time A, the recommended replacement time B, the recommended inspection time A, the recommended inspection time B, the recommended preparation time, and the preparation threshold also vary depending on the future operating condition.

According to the nozzle deformation amount managing apparatus 18 in the first embodiment described above, the past creep deformation amount and the past strain amount from the past to the present predicted based on the operation data of the actual steam turbine and the future creep deformation amount and the future strain amount predicted based on the assumed future operating condition can be displayed in the graph 101 in chronological order on the display part of the user interface 50. This allows the user to visually confirm the variation in the creep deformation amount or the strain amount over time.

Here, the progress of the creep deformation at the nozzle causes a risk of contact with the rotating rotor blade on the downstream side of the nozzle. This contact risk factor (risk factor) differs depending on the turbine stage. For example, the creep deformation amount has a greater influence as a risk factor on a smaller-sized nozzle (nozzle with a lower blade height) than on a larger-sized nozzle (nozzle with a higher blade height). Thus, the strain amount obtained by dividing the creep deformation amount by the nozzle height and making the found result dimensionless is used as one of the managed deformation amounts, and thereby the managed deformation amount that includes a nozzle size factor can be provided. Here, in the smaller-sized nozzle, the strain amount increases faster than the creep deformation amount over time. On the other hand, in the larger-sized nozzle, the creep deformation amount increases faster than the strain amount over time.

In the nozzle deformation amount managing apparatus 18, by using the creep deformation amount and the strain amount as the managed deformation amount, nozzle deformation amount management in consideration of the nozzle size factor can be executed. As a result, for example, as the alarm display 103, it is possible to display the recommended replacement time based on the replacement threshold that the creep deformation amount or the strain amount reached first out of the replacement threshold A and the replacement threshold B. Further, for example, as the alarm display 103, it is possible to display the recommended inspection time based on the inspection threshold that the creep deformation amount or the strain amount reached first out of the inspection threshold A and the inspection threshold B. Then, the nozzle deformation amount managing apparatus 18 can perform management so as to avoid the risk of contact with the rotor blade caused by the creep deformation of the nozzle.

Further, in the nozzle deformation amount managing apparatus 18, lines of the replacement threshold A, the replacement threshold B, the inspection threshold A, the inspection threshold B, and the preparation threshold can be displayed in the graph 101 on the display screen 100. This allows the user to visually confirm the recommended replacement time A, the recommended replacement time B, the recommended inspection time A, the recommended inspection time B, and the recommended preparation time.

Furthermore, in the nozzle deformation amount managing apparatus 18, the recommended replacement time A, the recommended replacement time B, the recommended inspection time A, the recommended inspection time B, and the recommended preparation time can be displayed on the display screen 100 as the alarm display 103. This allows the user to specifically recognize these times. Then, by specifically recognizing the recommended preparation time, the user can accurately request the manufacture of the nozzle to be replaced.

In the nozzle deformation amount managing apparatus 18, the arithmetic operation result based on the operating condition input on the input screen 80 for future operating conditions can be displayed. Therefore, by changing the operating condition on the input screen 80 for future operating conditions, the user can visually confirm the difference in the arithmetic operation result depending on the operating condition in the graph 101 on the display screen 100.

### Second Embodiment

In the second embodiment, there is explained another example of the information on the future creep deformation amount and the future strain amount to be displayed on the display part of the user interface 50.

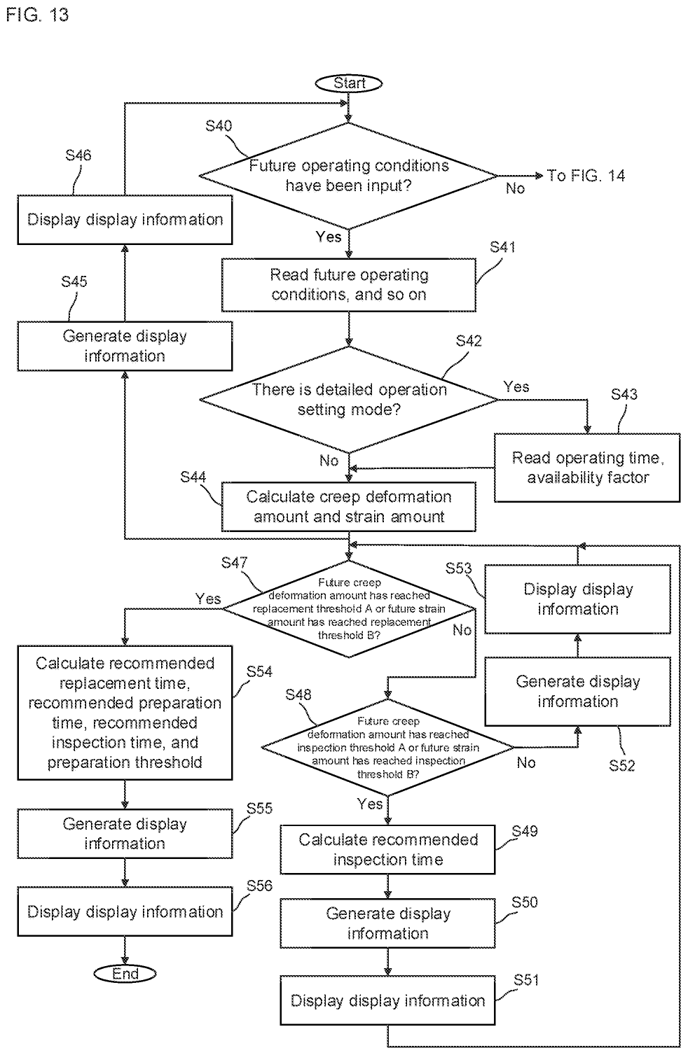

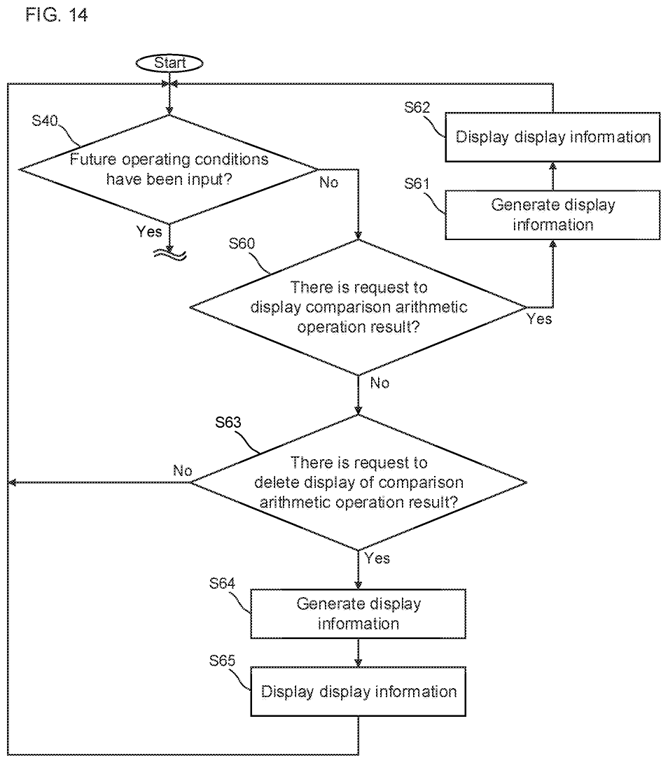

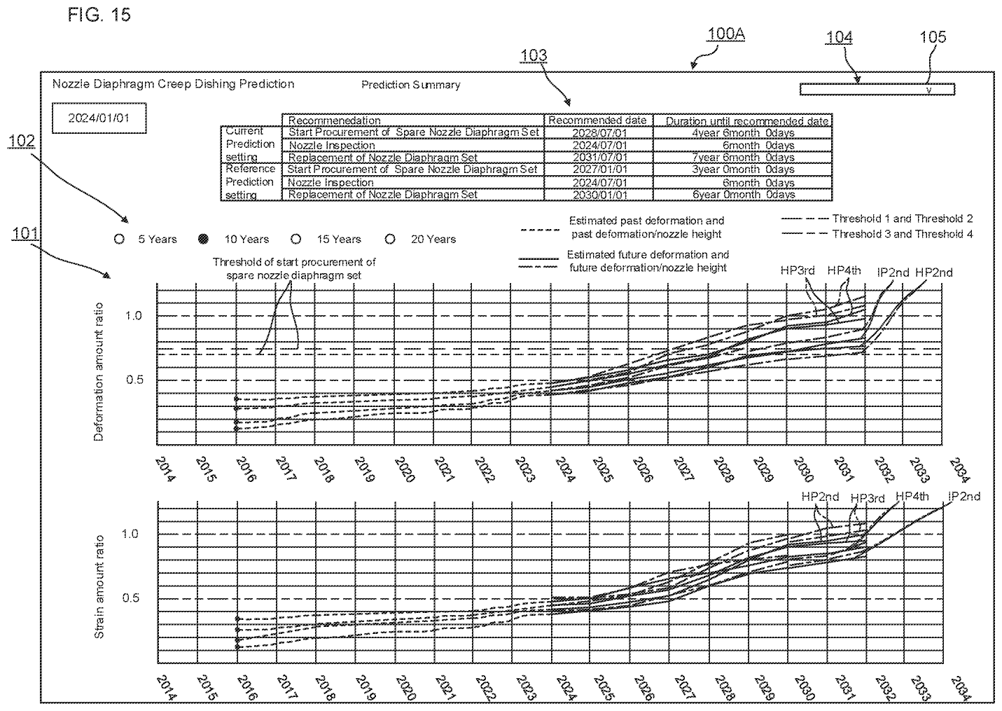

FIG. 13 and FIG. 14 are flowcharts for explaining a method of future deformation amount arithmetic operation processing in the nozzle deformation amount managing apparatus 18 in the second embodiment. Incidentally, the flowchart cannot be illustrated in one diagram due to the formation of the drawing, and thus the flowchart following “No” at Step S40 in FIG. 13 is illustrated in FIG. 14. FIG. 15 is a view illustrating one example of a display screen 100A in the nozzle deformation amount managing apparatus 18 in the second embodiment. Incidentally, in the second embodiment, the same reference numerals and symbols are added to the same components as those of the nozzle deformation amount managing apparatus 18 in the first embodiment, and redundant explanations are omitted or simplified.

The nozzle deformation amount managing apparatus 18 in the second embodiment differs from the nozzle deformation amount managing apparatus 18 in the first embodiment in that the arithmetic operation result under another future operating condition can be displayed simultaneously on the display screen 100A, which displays the arithmetic operation result. Here, this different configuration is mainly explained. Incidentally, the fixed-cycle deformation amount arithmetic operation processing in the second embodiment is the same as that in the first embodiment.

In the future deformation amount arithmetic operation processing in the second embodiment illustrated in FIG. 13 and FIG. 14, pieces of processing at Step S60 to Step S65 have been added to the future deformation amount arithmetic operation processing in the first embodiment.

Here, the user presses the Save button 87 in FIG. 3 after inputting the future operating conditions. In the future deformation amount arithmetic operation processing in the second embodiment, as in the future deformation amount arithmetic operation processing in the first embodiment, the user interface 50 receives the input from the Save button 87 and outputs information related to the future operating conditions to the input information storage section 61. The input information storage section 61 stores the information related to the future operating conditions.

Further, the future deformation amount arithmetic operation section 72 receives information in response to the press of the Save button 87 from the user interface 50, and determines that the future operating conditions have been input.

As illustrated in FIG. 13, the future deformation amount arithmetic operation section 72 determines whether or not the future operating conditions have been input (Step S40).

When it is determined in the determination of Step S40 that the future operating conditions have been input (Yes at Step S40), pieces of the processing at Step S41 to Step S46 are executed as described previously. Then, as described previously, after the processing at Step S46, the processing at Step S40 is executed.

On the other hand, when it is determined in the determination of Step S40 that the future operating conditions have not been input (No at Step S40), the display information generation section 73 determines whether or not there is a request to display a result obtained by performing the arithmetic operation under another future operating condition (comparison arithmetic operation result) (Step S60), as illustrated in FIG. 14. The comparison arithmetic operation result is an arithmetic operation result that has already been predicted based on another future operating condition, and has been stored in the arithmetic operation result storage section 64. Incidentally, another future operating condition functions as a second future operating condition, and the comparison arithmetic operation result functions as second future deformation amount related information.

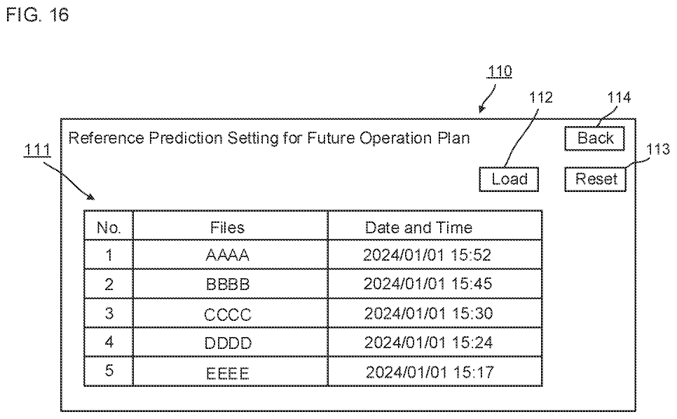

Here, FIG. 16 is a view illustrating one example of a selection screen 110 for selecting the comparison arithmetic operation result to be displayed on the user interface 50 in the nozzle deformation amount managing apparatus 18 in the second embodiment.

For example, by pressing the selection button 105 in the selection display portion 104 on the display screen 100 illustrated in FIG. 10, a selection item of the selection screen 110 is displayed in the selection display portion 104, although not illustrated. Then, when the selection item of the selection screen 110 is selected in the selection display portion 104, the screen of the display part of the user interface 50 is switched to the selection screen 110 illustrated in FIG. 16. At this time, the display information generation section 73 receives information related to the selection of the selection screen 110 from the user interface 50 and outputs display information for displaying the selection screen 110 to the user interface 50.

On the selection screen 110 in FIG. 16, a list of already arithmetically operated arithmetic operation results, which are stored in the arithmetic operation result storage section 64, is displayed in a list display portion 111. Further, there has been illustrated one example of the list display portion 111 that also displays dates and times stored in the arithmetic operation result storage section 64 here. In the list display portion 111, for example, file names of five arithmetic operation results are displayed in order of the latest date and time stored in the arithmetic operation result storage section 64. Incidentally, the structure displayed in the list display portion 111 is not limited to this. In the list display portion 111, a list of arithmetic operation results that have already been arithmetically operated only needs to be displayed.

Here, FIG. 16 illustrates one example of comparison arithmetic operation results that were arithmetically operated based on the future operating conditions within the past 1 hour. When these comparison arithmetic operation results are displayed in a graph 101 on the display screen 100A, the comparison arithmetic operation results can be compared in a state where the latest future creep deformation amount and the latest future strain amount are not updated. That is, no matter which of these comparison arithmetic operation results is displayed in the graph 101, the starting points of the lines indicating the future creep deformation amount ratio and the future strain amount ratio in the comparison arithmetic operation result coincide with the starting points of the lines indicating the latest future creep deformation amount ratio and the latest future strain amount ratio as illustrated in FIG. 15.

Incidentally, the comparison arithmetic operation result may be a result arithmetically operated more than one hour ago. For example, when selecting a comparison arithmetic operation result arithmetically operated several days ago, the starting points of the lines indicating the future creep deformation amount ratio and the future strain amount ratio in the comparison arithmetic operation result will deviate from the starting points of the lines indicating the latest future creep deformation amount ratio and the latest future strain amount ratio. Even when the respective starting points deviate as above, the variation trends in the future creep deformation amount ratio and the future strain amount ratio in the future can be compared.

The user selects the file name of the arithmetic operation result that the user wants to display on the display screen 100 illustrated in FIG. 10 as the comparison arithmetic operation result from the list displayed on the list display portion 111. Then, the user presses a Load button 112. When the user presses the Load button 112, the screen is switched to the display screen 100A to display the arithmetic operation results illustrated in FIG. 15.

Incidentally, a Back button 114 is a button to be pressed when returning to the display screen 100 without pressing the Load button 112 or a Reset button 113.

The display information generation section 73 receives a signal based on the press of the Load button 112 from the user interface 50, and determines at Step S60 that there is a request to display the comparison arithmetic operation result.

When determining in the determination of Step S60 that there is a request to display the comparison arithmetic operation result (Yes at Step S60), the display information generation section 73 generates display information based on the arithmetic operation results stored in the arithmetic operation result storage section 64 and the information stored in the template storage section 65 (Step S61). Here, the display information generation section 73 reads both the arithmetic operation results based on the future operating condition stored in the arithmetic operation result storage section 64 and the selected comparison arithmetic operation result. Then, the display information generation section 73 outputs the generated display information to the display information storage section 66 and the user interface 50. The display information storage section 66 stores the display information.

The user interface 50 displays the display information output from the display information generation section 73 on the display part as illustrated in FIG. 15 (Step S62). As illustrated in FIG. 15, on the display screen 100A, both the arithmetic operation results based on the future operating condition and the comparison arithmetic operation result are displayed as the future creep deformation amount and the future strain amount.

Specifically, as the future creep deformation amount and the future strain amount, the creep deformation amount ratio and the strain amount ratio in each of the arithmetic operation results are illustrated in chronological order, and at the same time, the line of the preparation threshold in each of the arithmetic operation results is illustrated.

Incidentally, the comparison arithmetic operation result has been illustrated by a dot and dash line, and the line of the preparation threshold in the comparison arithmetic operation result has been illustrated by a dotted line (dotted line with a narrower interval). Further, as the alarm display 103, the recommended replacement times A or the recommended replacement times B, the recommended inspection times A or the recommended inspection times B, and the recommended preparation times in the respective arithmetic operation results are displayed. Incidentally, as illustrated in FIG. 15, the creep deformation amount ratio and the strain amount ratio in the past creep deformation amount and the past strain amount have also been illustrated in chronological order.

Incidentally, the preparation threshold in the comparison arithmetic operation result functions as a second preparation threshold, the recommended replacement time A or the recommended replacement time B in the comparison arithmetic operation result functions as a second recommended replacement time, the recommended preparation time in the comparison arithmetic operation result functions as a second recommended preparation time, and the recommended inspection time A or the recommended inspection time B in the comparison arithmetic operation result functions as a second recommended inspection time.

When determining in the determination of Step S60 that there is no request to display the comparison arithmetic operation result (No at Step S60), the display information generation section 73 determines whether or not there is a request to delete the display of the comparison arithmetic operation result (Step S63).

Here, the user can delete the comparison arithmetic operation result displayed on the display screen 100A in FIG. 15 by pressing the Reset button 113 on the selection screen 110 in FIG. 16. The display information generation section 73 receives a signal based on the press of the Reset button 113 from the user interface 50, and determines at Step S63 that there is a request to delete the display of the comparison arithmetic operation result. Incidentally, when the user presses the Reset button 113, the screen is switched to the display screen to display the arithmetic operation results.

When determining in the determination of Step S63 that there is a request to delete the display of the comparison arithmetic operation result (Yes at Step S63), the display information generation section 73 generates display information based on the arithmetic operation results stored in the arithmetic operation result storage section 64 and the information stored in the template storage section 65 (Step S64). Here, the display information generation section 73 reads the arithmetic operation results based on the future operating condition stored in the arithmetic operation result storage section 64. Then, the display information generation section 73 outputs the generated display information to the display information storage section 66 and the user interface 50. The display information storage section 66 stores the display information.

The user interface 50 displays the display information output from the display information generation section 73 on the display part as illustrated in FIG. 10 (Step S65). That is, as illustrated in FIG. 10, on the display screen 100, the comparison arithmetic operation result is deleted and only the arithmetic operation results based on the future operating conditions are displayed.

When it is determined in the determination of Step S63 that there is no request to delete the display of the comparison arithmetic operation result (No at Step S63), the operation returns to the processing at Step S40.

Further, as illustrated in FIG. 13, after the processing at Step S44, the future deformation amount arithmetic operation section 72 determines whether or not the arithmetic operation result has reached the replacement threshold A or the replacement threshold B based on the arithmetic operation results at Step S44, as described previously (Step S47). Then, as described previously, pieces of the processing at Step S47 to Step S56 are executed.

The information on the future creep deformation amount and the future strain amount on the display screen 100A is updated each time the information in response to the press of the Save button 87 on the input screen 80 for future operating conditions and the press of the Load button 112 or the Reset button 113 on the selection screen 110 for comparison arithmetic operation results is received.

Incidentally, although there has been explained one example in which one arithmetic operation result is selected as the comparison arithmetic operation result here, the present invention may be set so that a plurality of comparison arithmetic operation results can be selected.

According to the nozzle deformation amount managing apparatus 18 in the second embodiment described above, the same operations and effects as those of the nozzle deformation amount managing apparatus 18 in the first embodiment can be obtained.

Further, according to the nozzle deformation amount managing apparatus 18 in the second embodiment, both the arithmetic operation results predicted based on the future operating condition and the comparison arithmetic operation result can be displayed on the display screen 100A as the future creep deformation amount and the future strain amount.

Thereby, the user can visually confirm the difference between the arithmetic operation results based on the future operating condition and the comparison arithmetic operation result in the graph 101 and the alarm display 103 on the display screen 100A.

According to the embodiments described above, it is possible to recognize in chronological order the creep deformation amount and the strain amount from the past to the present predicted based on the operation data and the future creep deformation amount and the future strain amount predicted based on the future operating conditions.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A steam turbine nozzle deformation amount managing apparatus comprising
a display information generation section configured to generate display information for displaying:
past deformation amount related information indicating information on a past deformation amount of a nozzle of a steam turbine from the past to the present calculated based on measured information; and
future deformation amount related information indicating information on a future deformation amount of the nozzle calculated based on a future operating condition input via a user interface screen and the past deformation amount related information.

2. The steam turbine nozzle deformation amount managing apparatus according to claim 1, wherein
the display information generation section generates the display information for displaying both the information on the past deformation amount and the information on the future deformation amount in chronological order.

3. The steam turbine nozzle deformation amount managing apparatus according to claim 1, wherein
the display information generation section generates the display information for displaying the past deformation amount related information at predetermined time intervals.

4. The steam turbine nozzle deformation amount managing apparatus according to claim 1, wherein
the display information generation section generates the display information for displaying the future deformation amount related information each time the future operating condition is input.

5. The steam turbine nozzle deformation amount managing apparatus according to claim 1, wherein
the display information generation section generates the display information for displaying information related to a preparation threshold that is calculated based on the future deformation amount and indicates a deformation amount at which it is recommended to start preparation for a new nozzle.

6. The steam turbine nozzle deformation amount managing apparatus according to claim 1, wherein
the display information generation section generates the display information for displaying a recommended preparation time that is calculated based on the future deformation amount and at which it is recommended to start preparation for a new nozzle.

7. The steam turbine nozzle deformation amount managing apparatus according to claim 1, wherein
the display information generation section generates the display information for displaying a recommended replacement time that is calculated based on the future deformation amount and at which it is recommended to replace the nozzle.

8. The steam turbine nozzle deformation amount managing apparatus according to claim 1, wherein
the display information generation section generates the display information for displaying a recommended inspection time that is calculated based on the future deformation amount and at which it is recommended to inspect the nozzle.

9. The steam turbine nozzle deformation amount managing apparatus according to claim 1, wherein
the display information generation section generates the display information for further displaying second future deformation amount related information that indicates information on a second future deformation amount of the nozzle in the future calculated based on a second future operating condition input via the user interface screen and the past deformation amount related information.

10. The steam turbine nozzle deformation amount managing apparatus according to claim 9, wherein
the display information generation section generates the display information for displaying information related to a second preparation threshold that is calculated based on the second future deformation amount and indicates a deformation amount at which it is recommended to start preparation for a new nozzle.

11. The steam turbine nozzle deformation amount managing apparatus according to claim 9, wherein
the display information generation section generates the display information for displaying a second recommended preparation time that is calculated based on the second future deformation amount and at which it is recommended to start preparation for a new nozzle.

12. The steam turbine nozzle deformation amount managing apparatus according to claim 9, wherein
the display information generation section generates the display information for displaying a second recommended replacement time that is calculated based on the second future deformation amount and at which it is recommended to replace the nozzle.

13. The steam turbine nozzle deformation amount managing apparatus according to claim 9, wherein
the display information generation section generates the display information for displaying a second recommended inspection time that is calculated based on the second future deformation amount and at which it is recommended to inspect the nozzle.
